(19) United States
(12) Patent Application Publication
(10) Pub. No.: US 2026/0222666 A1
(43) Pub. Date: Jul. 30, 2026

(54) SYSTEM AND METHOD FOR OBTAINING IMPROVED UNDERWATER IMAGES IN A FISH FARM

(71) Applicant: ReelData Inc., Dartmouth (CA)

(72) Inventors: Mathew Zimola, Halifax (CA); Rory S.E. O'Brien, Yarmouth (CA); Jonathan Saari, Dartmouth (CA)

(21) Appl. No.: 19/087,223

(22) Filed: Mar. 21, 2025

Related U.S. Application Data
(63) Continuation of application No. PCT/CA2025/050099, filed on Jan. 24, 2025.

(51) Int. Cl. H04N 23/50; A01K 61/95; G03B 15/02; G06T 7/00; H04N 7/18; H04N 23/51; H04N 23/54; H04N 23/56; H04N 23/66; H05B 45/10; H05B 45/325; H05B 45/50

(52) U.S. Cl. CPC H04N 23/555; A01K 61/95; G03B 15/02; G06T 7/0002; H04N 7/183; H04N 23/51; H04N 23/54; H04N 23/56; H04N 23/66; H05B 45/10; H05B 45/325; H05B 45/50; G03B 2215/0567; G06T 2207/20081; G06T 2207/30168

(57) ABSTRACT

Devices, systems, and methods for obtaining improved quality underwater images are described. For example, a fish deterrent, that may be used with an underwater camera, comprises: a least one fish deterrent barrier; and an attachment element for releasably mounting to the camera housing, wherein the at least one first deterrent barrier extends outwardly from the camera housing in a same direction as the camera's field of view. As another example, an underwater camera comprises: a housing; at least one image sensor mounted at the housing; two or more light sources that are independently controllable for generating light beams and mounted at the housing laterally offset from and on either side of the at least one image sensor; and a lighting control system having a computing device that is configured to dynamically adjust light intensity of the generated light beams from at least one of the two or more light sources.

### CROSS-REFERENCE TO RELATED PATENT APPLICATION

This application is a continuation of International Application No. PCT/CA2025/050099 which claims the benefit of priority of U.S. Provisional Patent Applicant No. 63/625,772 filed on Jan. 26, 2024, and the entire contents of both of these applications are hereby incorporated by reference for all purposes.

### FIELD

Various embodiments are described herein that generally relate to a system for sampling biomass, as well as the methods.

### BACKGROUND

The following paragraphs are provided by way of background to the present disclosure. They are not, however, an admission that anything discussed therein is prior art or part of the knowledge of persons skilled in the art.

Land-based aquaculture is a new approach to the production of fish. Rather than using the natural habitat of the fish in the ocean and growing fish in ocean-based cages, land-based aquaculture brings fish on land by recreating their natural environment in tanks. The systems constantly have water circulating and filtering through the tanks and attempt to obtain the optimal balance of environmental parameters to assure fish health and growth. This closed system approach comes with many benefits including eliminating problems related to contamination, environmental optimization, parasites, predators, and escapes. Furthermore, it enables farms to be close to consumer markets resulting in decreased transportation distances and thus lower emissions.

However, land-based aquaculture utilizing Recirculating Aquaculture Systems (RAS) present challenges with regards to sampling biomass. Existing artificial intelligence (AI) camera solutions, primarily developed for the ocean industry, encounter significant limitations when applied to land-based environments. These challenges arise from higher stocking density, artificial currents, variable lighting conditions, and a broad range of tank sizes, making it important to address multiple complexities for obtaining underwater images with adequate quality for monitoring and further processing by computer vision intelligence solutions.

There is a need for technology that addresses the challenges and/or shortcomings described above.

### SUMMARY OF VARIOUS EMBODIMENTS

Various embodiments of a system and method for obtaining improved underwater images as well as devices and computer products for use therewith, are provided according to the teachings herein.

According to one aspect of the teachings herein, there is disclosed a fish deterrent for use with an underwater camera having a camera housing and at least one image sensor for underwater imaging wherein the fish deterrent comprises: at least one fish deterrent barrier; and an attachment element for releasably mounting the at least one fish deterrent to the camera housing, wherein the at least one first deterrent barrier extends outwardly from the camera housing in a same direction as a field of view (FOV) of the camera.

In at least one embodiment, the at least one fish deterrent barrier comprises a first deterrent side barrier that extends outwardly from the camera housing with respect to a first side of the at least one image sensor in the same direction of the FOV of the camera.

In at least one embodiment, the at least one fish deterrent comprises a second deterrent side barrier that extends outwardly from the camera housing with respect to a second side of the last one image sensor in the same direction as the FOV of the camera.

In at least one embodiment, the deterrent side barrier is a sidewall that is vertically oriented defining an open face, an open top and an open bottom for the fish deterrent.

In at least one embodiment, the sidewalls are angled outwards with respect a plane defined by the at least one image sensor.

In at least one embodiment, the amount of the angle is selected so that the deterrent side barriers encompass a combined FOV of a stereo camera.

In at least one embodiment, the at least one fish deterrent barrier includes a central deterrent barrier that extends outwardly from the camera housing in the same direction as the FOV and within the FOV of the camera.

In at least one embodiment, the central deterrent barrier has an arciform shape.

In at least one embodiment, the central deterrent barrier has upper and lower members defining a space therebetween.

In at least one embodiment, the upper and lower members have triangular shapes.

In at least one embodiment, the camera has two image sensors, and the central deterrent barrier is mounted between the two image sensors.

In at least one embodiment, the at least one deterrent barrier comprises holes to have a reduced effect on current at a location of the camera.

In at least one embodiment, the at least one deterrent barrier includes a wall made of mesh.

In at least one embodiment, a given deterrent side barrier has a frame with upper front, lower front and rear segments and the frame has a trapezoidal shape with the rear segment being shorter than the front segment and the rear segment being adjacent to the camera housing.

In at least one embodiment, the at least one deterrent barrier includes an attachment element that is rod shaped for attachment to the camera housing.

In at least one embodiment, the fish deterrent comprises an attachment frame that is connected to the at least one deterrent barrier and is mounted to the camera housing.

In another aspect, in accordance with the teachings herein, there is provided at least one embodiment of an underwater camera for use in one or more aquaculture fish tanks, wherein the camera comprises: a housing; at least one image sensor mounted on the housing; two or more light sources that are independently controllable for generating light beams, the two or more light sources being mounted at the housing laterally offset from the at least one image sensor with the at least one image sensor located between the two or more light sources; and a lighting control system having a computing device that is configured to dynamically adjust light intensity of the generated light beams from at least one of the two or more light sources.

In at least one embodiment, the underwater camera comprises at least two image sensors mounted at the housing.

In at least one embodiment, the lighting control system comprises: light source driver circuitry for providing drive currents to the light sources; and a microcontroller that is configured for generating and sending light control signals to the light source driver circuitry for controlling an intensity of the light beams generated by at least one of the at least two light sources based on instructions received from the computing device.

In at least one embodiment, the light sources are LEDs and the microcontroller uses pulse width modulation for the light control signals to control the operation of the two or more light sources, wherein the pulse width modulation is performed at a high frequency of 1 KHz or more.

In at least one embodiment, capacitors are coupled to each of the light sources to smooth out any variation in light intensity of the generated light beams.

In at least one embodiment, the light control signals are adapted so that any change to light intensity of the generated light beams is made in a gradual fashion.

In at least one embodiment, the lighting control system includes power supply circuitry that is configured to provide a first power supply voltage level to the light source driver circuitry and a second power supply voltage to edge computing device where the first power supply voltage level is higher than the second power supply voltage level.

In at least one embodiment, the microcontroller generates the light control signals so that the light intensity of the light beams generated by each light source is in the range of about 0 lumens to about 4,000 lumens each.

In at least one embodiment, the light sources are angled with respect to a front face of the housing so that the generated light beams are directed in an inward fashion to provide an increase in illumination for a field of view of a single image sensor when the at least one image sensor is the single image sensor or for a combined field of view for a stereo pair of image sensors when the at least one image sensor is the stereo pair of image sensors.

In at least one embodiment, the computing device receives control commands from a remote device operated by a user and processes the control commands to generate instructions that are provided to the microcontroller and/or the underwater camera wherein the control commands include values for any combination of basic camera settings, advanced camera settings and light control parameters.

In at least one embodiment, the basic camera settings include any combination of exposure, contrast and brightness.

In at least one embodiment, the advanced camera settings include any combination of gain, gamma, saturation, white balance, hue and sharpness.

In at least one embodiment, the computing device is configured to execute software for implementing an automated lighting control method to determine image quality for a current image and to determine control instructions when the image quality is not acceptable.

In at least one embodiment, the image quality is determined based on any combination of light/darkness, average pixel intensity, histogram spread, one or more color balance metrics, blur, sharpness, contrast, noise, color accuracy, and dynamic range.

In at least one embodiment, the image quality is determined using an image quality machine learning (ML) model.

In at least one embodiment, the control instructions are determined using one or more control instruction recommendation ML models that are provided with input features based on any combination of the current image, the current camera settings and the current light control settings.

In at least one embodiment, the input features include any combination amount of light/darkness, average pixel intensity, histogram spread, one or more color balance metrics, blur, contrast, edge sharpness, specular reflections and backscatter metrics and edge detection measures.

In at least one embodiment, the at least one environmental measurement is provided as one of the input features to the one or more control instruction recommendation ML model(s).

In at least one embodiment, the underwater camera comprises one or more sensors for obtaining the environmental measurements.

In at least one embodiment, the computing device is configured to receive a portion of the environmental measurements from a user.

In at least one embodiment, the environmental data includes fish stocking density data, time data, temperature data, current lighting condition data, or any combination thereof.

In at least one embodiment, the control instructions include light intensity control, polarization filtering control, spectral processing control, camera settings control, or any combination thereof.

In at least one embodiment, the camera settings control instructions include any combination of exposure rate, gain, color balance, capture rate, brightness, contrast, white balance, gamma, hue, saturation, and sharpness.

In at least one embodiment, the computing device is an edge computing device including a GPU or an NPU.

In at least one embodiment, the housing comprises a mounting plate for mounting the at least one image sensor and the light sources and watertight enclosures that encapsulate the image sensors and the light sources.

In at least one embodiment, the lighting sources are mounted adjacent to different corners of the mounting plate.

In at least one embodiment, the housing further comprises a port enclosure for receiving a port of a cable that provides power and data communication for the underwater camera.

In at least one embodiment, the underwater camera further comprises a polarization filter for reducing glare and/or specular reflection.

In at least one embodiment, the underwater camera further comprises a fish deterrent that is defined according to any of the embodiments described herein.

In another aspect, in accordance with the teachings herein, there is provided a system for allowing underwater monitoring of marine life in an aquaculture tank, wherein the system comprises: a networking unit that is adapted to be removably mounted to the aquaculture tank, the networking unit providing power and network communications; and an underwater camera having a lighting control system, the underwater camera being coupled to the networking unit and adapted for placement with the aquaculture tank, wherein the underwater camera is defined according to any of the embodiments described herein.

In at least one embodiment, the underwater camera includes a fish deterrent that is defined according to any of the embodiments described herein.

In at least one embodiment, in accordance with the teachings herein, there is provided a use of a system for underwater monitoring of marine life in an aquaculture tank, wherein the system is defined according to any of the embodiments described herein.

In another aspect, in accordance with the teachings herein, there is provided at least one embodiment of a method for performing underwater monitoring of marine life in an aquaculture tank, wherein the method comprises: using an underwater camera in the aquaculture tank, the underwater camera being defined according to any of the embodiments described herein; providing a monitor and control interface on a display of a remote device to a user, the interface showing at least one image acquired by the underwater camera, current values for camera settings and/or light control parameters of the underwater camera; receiving updated values for the camera settings and/or the light control parameters from the user; sending the updated values to the underwater camera from the remote device; and adjusting the camera settings and/or light control parameters based on the updated values.

In at least one embodiment, the camera settings comprise basic camera settings that include any combination of exposure, contrast and brightness.

In at least one embodiment, the camera settings comprise advanced camera settings that include any combination of gain, gamma, saturation, white balance, hue and sharpness.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a schematic diagram of an example embodiment of a system for monitoring fish in a fish farm.

FIGS. 2A-2B show front and rear perspective views, respectively, of an example embodiment of an underwater camera.

FIGS. 2C-2D show front and top views of an LED that may be used as the light sources on the right side for the underwater cameras discussed herein.

FIG. 2E shows an example of the light rays from the light sources and the Fields of View (FOVs) of the example stereoscopic camera of FIGS. 2A-2B.

FIG. 3 shows a schematic diagram of an example embodiment of a tank-side networking unit.

FIG. 4 shows a front view of an example embodiment of a fish farm with a plurality of tanks, tank-side networking units and an underwater camera in one of the tanks.

FIG. 5A shows a block diagram of an example embodiment of electronic hardware including an LED controller that may be used with an underwater camera for a fish farm.

FIG. 5B shows an example embodiment of a light control graphical user interface for use in controlling parameter settings of the underwater cameras described herein.

FIG. 6A shows a flow chart diagram of an example embodiment for a lighting control method for use with one of the underwater camera embodiments described herein.

FIG. 6B shows a flow chart diagram of another example embodiment of a lighting control method for use with one of the underwater camera embodiments described herein.

FIG. 7A shows an example of the problem of object size and position determination relative to a single camera.

FIG. 7B shows an example of using a multi-camera array to determine object size and position relative to the multi-camera array.

FIGS. 7C and 7D show top and side schematic views of an example embodiment of an underwater camera with stereoscopic sensors along with a fish deterrent.

FIGS. 8A-8B show top views of a fish farm tank with an example embodiment of fish deterrents attached to underwater cameras.

FIGS. 9A-9D show perspective, top, front, and side views of an example embodiment of a fish deterrent for use with an underwater camera for underwater imaging.

FIGS. 10A-10D show perspective, top, front, and side views, respectively, of the fish deterrent of FIGS. 9A-9D attached to an underwater camera for underwater imaging.

FIGS. 11A-11D show perspective, top, front, and side views, respectively, of an example embodiment of a fish deterrent attached to an underwater camera for underwater imaging.

FIGS. 12A-12D show top, perspective, front, and side views, respectively, of an example embodiment of a fish deterrent for use with an underwater camera for underwater imaging.

FIGS. 13A-13D show top, perspective, front, and side views, respectively, of the fish deterrent of FIGS. 12A-12D attached to an underwater camera for underwater imaging.

FIGS. 14A-14D show top, perspective, front, and side views, respectively, of an example embodiment of a fish deterrent for use with an underwater camera for underwater imaging.

FIGS. 15A-15D show top, perspective, front, and side views, respectively, of the fish deterrent of FIGS. 14A-14D attached to an underwater camera for underwater imaging.

FIGS. 16A-16D show top, perspective, front, and side views, respectively, of an example embodiment of a fish deterrent for use with an underwater camera for underwater imaging.

FIGS. 17A-17D show top, perspective, front, and side views, respectively, of an example embodiment of the fish deterrent of FIGS. 16A-16D attached to an underwater camera for underwater imaging.

FIGS. 18A-18D show bottom, perspective, front, and side views, respectively, of an example embodiment of a fish deterrent attached to an underwater camera for underwater imaging.

FIGS. 19A-19D show top, perspective, front, and side views, respectively, of an example embodiment of a fish deterrent attached to an underwater camera for underwater imaging.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z”, “any combination of X, Y and Z” or “X, Y, Z or any combination thereof is intended to mean X, or Y, or Z, or X and Y, or X and Z, or Y and Z, or X, Y and Z.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should also be noted that the use of the term “window” or graphical user interface “GUI” in conjunction with describing the operation of any system or method described herein is meant to be understood as describing a user interface for performing initialization, configuration, or other user operations.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object oriented programming. The program code may be written in C⁺⁺, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

It should be noted that while the term biomass camera has been used to refer to the various camera embodiments described herein, and these cameras may also be referred to as underwater cameras or submersible cameras.

It should also be noted that while the term fish tank or fish farm has been used in association with the description of the teachings herein, it may be possible to use the various embodiments of the tank-side networking units and underwater cameras described herein more generally with aquaculture tanks which may contain other forms of marine life.

Various embodiments of systems and methods for sampling biomass in a fish farm, and related computer products and hardware, are described herein.

For example, in one aspect, at least one of the embodiments described herein address issues and solve technical problems related to obtaining good quality images, e.g., obtaining good quality underwater images of fish or other marine animals is important for downstream analysis for various applications such as sampling biomass in a fish farm.

Some challenges include the artificial current in RAS, flow through systems (FTS), or other land-based facility design types, which normally causes fish to remain relatively fixed in position with reference to the camera system, leading to biased metrics and potentially continuous data generation of the same fish.

As another example, in a second aspect, at least one of the embodiments described herein address issues and solve technical problems related to the ever-changing fish growth and variable stocking density in the tanks resulting in a constant varying light attenuation through the water column, further complicating accurate monitoring.

As another example, in a third aspect, at least one of the embodiments described herein address issues and solve technical problems related to high capital expenditure costs and technical issues associated with using unique biomass cameras in each fish tank by providing a portable underwater camera system in which underwater cameras can be moved from tank to tank requiring less overall hardware for a fish farm.

In another example, in a fourth aspect, at least one of the embodiments described herein address issues and solve technical problems with obtaining images that show a complete fish versus an incomplete fish. Images showing incomplete fish may be obtained when a large fish is too close to an underwater camera or a fish is not completely within the field of view of an underwater camera.

In another example, in a fifth aspect, at least one of the embodiments described herein address issues and solve technical problems with obtaining images with sufficient image quality to allow for more accurate biomass estimation through dynamic lighting control. For example, in at least one embodiment, there may be remote control of one or more parameters of the underwater camera to perform dynamic lighting control to improve the image quality of the obtained images. Alternatively, or in addition thereto, in at least one embodiment, dynamic lighting control may be implemented using an automated lighting control method that can adapt to variable lighting conditions due to a variety of reasons and environments thereby allowing improved accuracy for analyses based on the acquired images such as fish biomass determination, for example.

In another example, in a sixth aspect, at least one of the embodiments described herein, provides an underwater camera that is configured to be mobile and reduce disruption of the fish in the tank. For example, the portability and light weight of the underwater cameras described herein allows a user to easily move the underwater camera between different tanks and within a given tank reposition the underwater camera to lower and/or raise the underwater camera position, as well as move the underwater camera around the fish tank to overcome stratification/current bias. This is advantageous since the particular size/shape of a fish tank can cause vertical changes in the flow velocity. Smaller (weaker) fish will avoid stronger currents, which may affect where the fish are located in the tank. There may also be different salinity, oxygen, and other chemical concentrations as a function of depth in the tank (especially in the ocean, but also in a land-based tank) which may affect where fish are located in the tank. In addition, if fish are hungry, they may congregate near the top of the tank, or may sink to lower depths in the tank if they're fed. Therefore, there can be a depth-related distribution in average biomass of the tank. Advantageously, the underwater cameras described herein are structured so that it is easy to raise or lower the camera and/or position the underwater at different circumferential locations to deal with the fish location distribution problem.

Alternatively, or in addition thereto, the underwater camera has a housing and physical layout so that the underwater camera has a low-profile (e.g., is thin) so as to minimally protrude from a wall of the fish tank. For example, the camera may be structured to have a thickness from front to back on the order of about 10 cm to about 15 cm which is beneficial for several reasons. For example, the hydrodynamics of an aquaculture tank preferably creates substantially homogenous rearing conditions. This facilitates cleaning and helps maintain appropriate flow velocities for the size and aspects of the fish reared. Any abrupt changes to the surface/condition of the tank changes these flow characteristics. For example, the currents are lower at the edge of the tank than they are nearer the middle and it is desired to limit creating eddies where small fish will congregate which is why the underwater camera has a thin profile. Secondly, advantageously, the low profile of the underwater cameras described herein and having a chassis that is porous helps keep the weight down so it is easy to move to various locations in a fish tank and also is not so large that it would otherwise cause fish to deviate too heavily from their normal swim paths or for them to run into/bite through.

In another example, at least one embodiment is described herein which may be based on any combination of the first, second, third, fourth, fifth and sixth aspects described above.

The various embodiments of the underwater camera and systems described herein may result in biomass camera technology that may accommodate for a wide range of tank sizes, for example, from smaller tanks with 500 fish to larger tanks containing up to 200,000 fish, providing an economically viable and scalable option for the industry. This may benefit the aquaculture sector, for example, by providing increased biomass estimates that may be used to improve productivity, improve fish quality, and promote more sustainable farming practices within land-based aquaculture (RAS/FTS) setups.

It should be noted that while reference is made to land-based fish farms through various example embodiments that are described herein, the teachings herein can also be applied for biomass cameras that are used for offshore or near-shore fish farms where some modifications may be made based on environmental conditions that are more unique to offshore or near-shore fish farms.

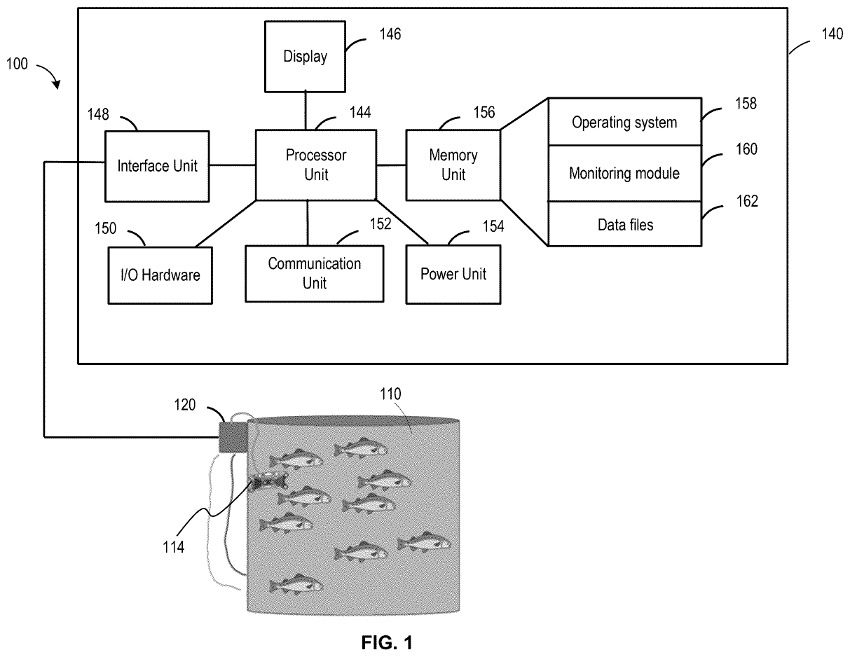

Reference is first made to FIG. 1, showing a schematic diagram of an example embodiment of an underwater monitoring system 100 for a fish farm. The system 100 includes a tank 110, an underwater camera 114, a tank-side networking unit 120, and a computer 140. It should be noted that in alternative embodiments, some elements may be implemented using other elements such as an ethernet cable, and the networking unit 120 which may be implemented using other networking elements. The networking unit 120 may be any device that allows for wired or wireless communication from the underwater camera 114 to the computer 140, such as a switch, a router, a hub, a USB port, an Ethernet cable, etc.

The underwater camera 114 is located in the tank 110 and is portable so that it can be moved around the tank 110 to be at different positions (e.g., different circumferential positions) around the tank 110 and levels (e.g., different heights) within the tank 110. This enables the collection of high-quality image data for objects that pass in front of the underwater camera 114 and are captured in the images acquired by the underwater camera 114 (e.g., these images may be part of a video feed, images taken periodically, images taken on command, etc.). The position for placement of an underwater camera 114 depends on the fish farm and can vary from fish farm to fish farm.

As camera technology continues to develop every year, the technical specifications for the underwater camera 114 may evolve over time. Certain specifications for the underwater camera 114 that may change are resolution and exposure. For example, a resolution of 576×704 and an exposure of 1/250 may be suitable for use with the system 100. However, other resolutions may be used such as 2208×1242 (e.g., roughly 2k), 4k, 8k, higher resolutions as well as lower resolution such as 640×480. Exposure, gain, and other settings may be selected and varied dependent on imaging environment and sensor type such as an exposure time that is less than about 500 ms and more than about 5 ms.

The computer 140, which may be referred to as a computing device, may be implemented as a single computing device (e.g., a desktop, laptop, or notepad/tablet), and includes a processor unit 144 (which may be referred to as having one or more processors or just a processor for ease of illustration), a display 146, an interface unit 148, input/output (I/O) hardware 150, a communication unit 152, a power unit 154, and a memory unit (also referred to as “data store”) 156. The memory unit 156 includes non-transient computer-readable medium hardware which stores computer instructions thereon for use by the processor unit 144. In other embodiments, the computer 140 may have more or less components but generally functions in a similar manner. For example, the computer 140 may be implemented using more than one computing device and/or processor unit 144. For example, the computer 140 may be implemented to function as a server or a server cluster.

The processor unit 144 controls the operation of the system 100 and may include one processor that can provide sufficient processing power depending on the configuration and operational requirements of the system 100. For example, the processor unit 144 may include a high performance processor or a Graphics Processing unit (GPU), in some cases. Alternatively, there may be a plurality of processors that are used by the processor unit 144, and these processors may function in parallel and perform certain functions.

The display 146 may be, but is not limited to, a computer monitor or an LCD display such as that used for a tablet device or a desktop computer depending on the implementation of the computer 140.

The interface unit 148 can be any interface that allows the processor unit 144 to communicate with other devices within the system 100. In some embodiments, the interface unit 148 may include at least one of a serial bus or a parallel bus, and a corresponding port such as a parallel port, a serial port, a USB port and/or a network port. For example, the network port can be used so that the processor unit 144 can communicate via the Internet, a Local Area Network (LAN), a Wide Area Network (WAN), a Metropolitan Area Network (MAN), a Wireless Local Area Network (WLAN), a Virtual Private Network (VPN), or a peer-to-peer network, either directly or through a modem, router, switch, hub or other routing or translation device.

The I/O hardware 150 can include, but is not limited to, at least one of a microphone, a speaker, a keyboard, a mouse, a touch pad, a display device and a printer, for example.

The power unit 154 can include one or more power supplies (not shown) connected to various components of the system 100 for providing power thereto as is commonly known to those skilled in the art.

The communication unit 152 includes various communication hardware for allowing the processor unit 144 to communicate with other devices. For example, the communication unit 152 includes at least one of a network adapter, such as an Ethernet or 802.11x adapter, a Bluetooth radio or other short range communication device, or a wireless transceiver for wireless communication, for example, according to CDMA, GSM, or GPRS protocol using standards such as IEEE 802.11a, 802.11b, 802.11g, or 802.11n.

The memory unit 156 may be volatile and/or non-volatile, non-removable or removable memory such as RAM, ROM, EEPROM, solid-state memory, hard disks, CD, DVD, flash memory, or the like. In use, the memory unit 156 is generally divided to a plurality of portions for different use purposes. For example, a portion of the memory unit 156 (denoted as storage memory herein) may be used for long-term data storing, for example, for storing files or databases. Another portion of the memory module 156 may be used as the system memory for storing data during processing (denoted as working memory herein).

The memory unit 156 stores program instructions for an operating system 158, a monitoring module 160, and data files 162. When any of the program instructions for the monitoring module 160 are executed by at least one processor of the processor unit 144 or at least one processor of another computing device, the at least one processor is configured for performing certain functions in accordance with the teachings herein. It should be noted that in alternative embodiments, the monitoring module 160 may be organized in other ways using different software programming structures as long as the main functionality described herein is provided. The operating system 158 is able to select which physical processor is used to execute certain software modules and other programs. For example, the operating system 158 is able to execute processes on different parts of the physical hardware that is used, e.g., using different cores within a processor, or different processors on a multi-processor server, for example.

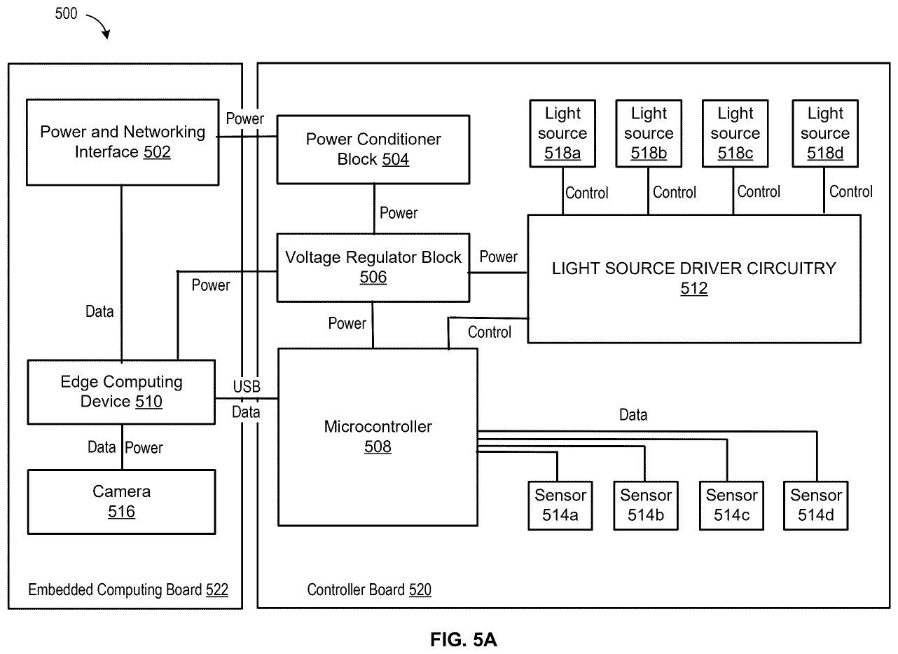

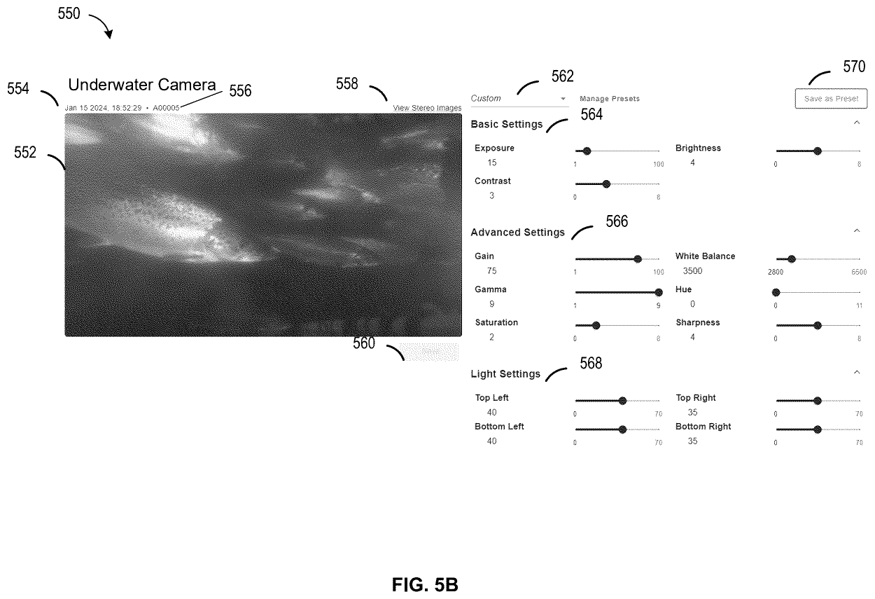

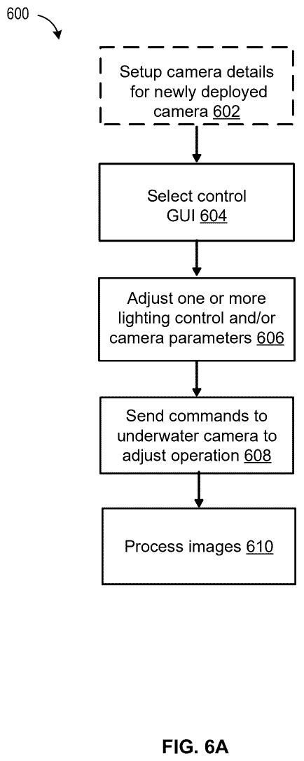

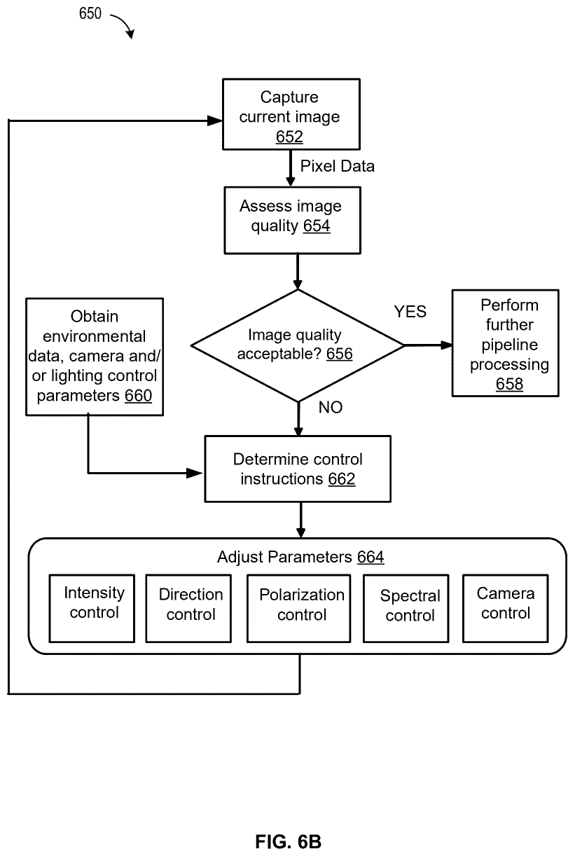

The monitoring module 160 includes program instructions for performing various functions related to underwater monitoring of marine life such as, but not limited to, obtaining underwater images, and remotely adjusting lighting conditions to improve image quality (e.g., which may be done in real-time), as is further described herein, and have various benefits such as increasing the accuracy of biomass sampling. For example, the software instructions of the monitoring module 160, may configure the at least one processor to generate one or more Graphical User Interfaces (GUIs) that allow a user to interact with and control the underwater camera 114. For example, the at least one processor may receive commands from user input via a control GUI for adjusting certain operational parameters of the underwater camera 114 such as generated light intensity, for example. The at least one processor may also be configured to display one or more images via the GUI, and optionally sensor data, for example. In at least one embodiment, the user may interact with a GUI to set parameters for the underwater camera 114 such as the fish tank 100 that the underwater camera 114 is mounted in and optionally information about the fish in the fish tank 100 such as, but not limited to, fish species and/or fish maturity/age. The control GUI is described in further detail with respect to FIGS. 5B and 6A.

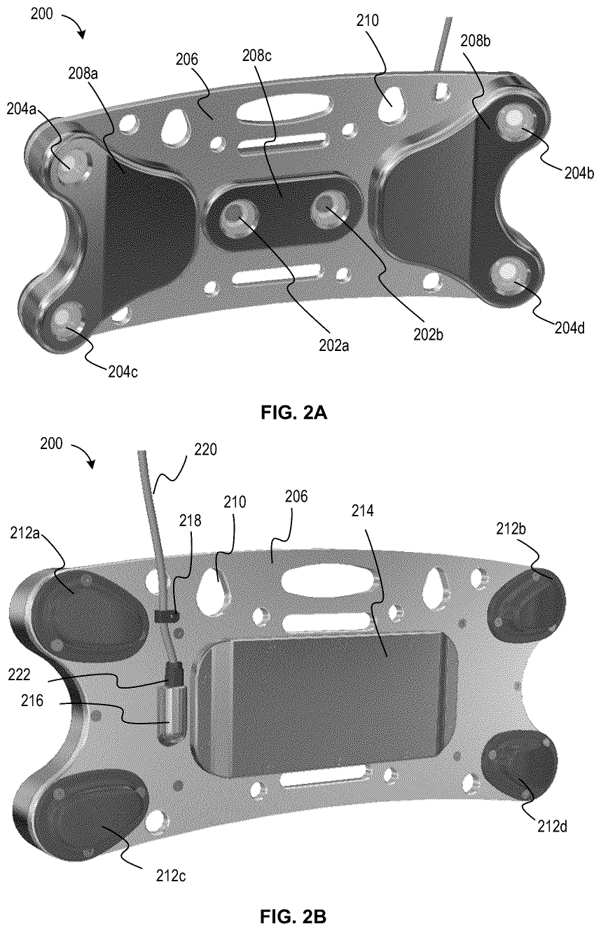

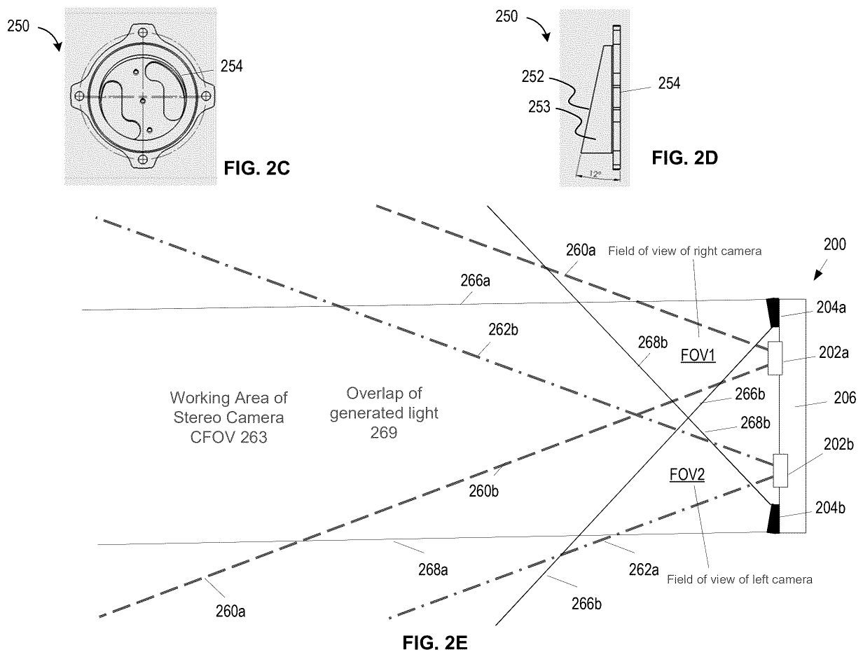

Referring now to FIGS. 2A and 2B, shown therein are front and rear perspective views of an example embodiment of an underwater camera 200 for land-based aquaculture. The underwater camera 200 generally includes a housing comprising a stereoscopic camera having two image sensors 202a and 202b as well as lenses and hardware that are configured to capture images of fish in a fish tank and light sources 204a-204d that are located and spaced apart on the outer sides of the image sensors 202a and 202b. In this example embodiment, the housing includes a support plate 206 (e.g., chassis) with enclosures 208a-208c on a forward facing surface of the support plate 206 and support pads 212a-212d, an enclosure 214, a port enclosure 216 and a cable support member 218 for a data and power cable 220.

It should be noted that in other alternative embodiments, there may be a different number and/or location of the light sources 204a-204d as well as the support pads 212a-212d and there may also be a different shape for the support plate 206. For example, in an alternative embodiment the support plate 206 may still be planar and have a triangular or elliptical shape and there may be three light sources located in a triangular pattern and spaced apart from and around the image sensors and there may be three support pads that may also be located in a triangular pattern.

The support plate 206 provides a surface upon which the components of the stereoscopic camera as well as the light sources 204a-204d are mounted. The support plate 206 may also include one or more apertures 210 for releasably receiving fasteners, such as screws or bolts, for allowing the underwater camera 200 to be releasably mounted to another object in a fish tank such as a wall of the fish tank. The support plate 206 may be made of material that does not release any chemicals into the water of the fish tank and the material also does not dissolve with any cleaning chemicals that are used in the fish tank.

The enclosures 208a-208c on the front or forward looking surface of the support plate 206 encapsulate the light sources 204a-204d and various components of the stereoscopic camera including the images sensors 202a and 202b. The encapsulation is meant to provide a watertight seal so that water does not damage any of these electrical components of the underwater camera 200. Likewise, the enclosure 214 on the rear surface of the support plate 206 provides a watertight housing for other electronic components of the biomass camera 200 including a dynamic lighting control system that is described in further detail with respect to FIGS. 5A-6B. The dynamic lighting control system can be used to independently control two or more of the light sources 204a-204d, allowing for improved lighting conditions which allow for acquiring better quality images which may allow for better monitoring of the marine life in the tank and also more accurate biomass measurements (e.g., quantity and/or size of marine life in the tank).

The port enclosure 216 on the support plate 206 provides a watertight enclosure around a female port (not shown) that receives a male connector 222 that is at the end of the cable 220. The cable support member 218 may be a clip or the like that is used to hold the cable 220 in place. The cable provides data connectivity and power for the components of the underwater camera 200. Accordingly, the female port is connected to a circuit board (not shown) that is within the enclosure 214. Various components of the lighting control system are mounted on the circuit board (an example embodiment for this is described in FIG. 5A).

In at least one alternative embodiment, the underwater camera 200 may include one or more sensors (not shown) to measure data that is used to monitor one or more conditions in the tank. The sensor(s) may be releasably or permanently mounted on the support plate 206 of the underwater camera 200. In alternative embodiments, one or more external sensors that may be physically separate from the underwater camera 200 and the data measured by these sensors may be provided to at least one processor of the camera 200 where the sensor data may be processed, such as for altering the dynamic operation of the lighting control system, and/or the sensor data may be provided to the at least one processor of the processor unit 144 where it may be processed and/or displayed for monitoring.

Referring now to FIGS. 2C-2D, shown therein are front and tops views of an LED 250 that may be used as the light sources for any of the underwater cameras discussed herein. The LED 250 may include a base 254 with a housing 253 that is structured so that the LED 250 is angled horizontally such that the face of the LED 250 is directed horizontally inwards towards the centerline of the underwater camera. Accordingly, the light beam generated by the LED 250 during use is angled horizontally inwards with respect to a plane that is defined by at least one image sensor for mono-sensor camera versions or both image sensors 202a and 204a for stereoscopic camera versions, an example of which is shown in FIG. 2E. The LED 250 is oriented when mounted such that the face 254 of the LED 250 is angled horizontally towards a vertical midline between the stereo pair of image sensors of the underwater camera so that light beams from light sources located near opposite sides of the chassis 206 (e.g., support plate) overlap with one another as shown in FIG. 2E. The angling of the light sources horizontally inwards is because the stereo pair of cameras are horizontally oriented. If the stereo pair of cameras were vertically oriented, then the top and bottom offset light sources may then instead be vertically angled towards a horizontal midline between the stereo pair of image sensors. With either of these embodiments, the angling inwards of the generated light beams aids with providing more illumination in a field of view of a single camera embodiment or the combined field of view of a stereo camera embodiment (as explained for FIG. 2E). However, the angle of the light sources may also be selected such that the angled light beam reduces any glare/specular reflection from fish scales that would otherwise be sensed by the light sensors 252a and 252b.

Referring now to FIG. 2E, shown therein is an example of the light rays from the light sources and the FOVs of the example stereoscopic camera 200 in accordance with the teachings herein. While one pair of light sources 204a and 204b are shown, the description of FIG. 2E also applies to the other pair of light sources 204c and 204d. The image sensor 202a has a first field of view (FOV1) indicated by boundaries 260a,260b while the image sensor 202b has a second field of view (FOV2) indicated by boundaries 262a,262b. The overlap of the fields of view FOV1 and FOV2 represents the combined field of view (CFOV) or working area 263 of the stereoscopic camera 200 and the CFOV defines the location of the scene for which images are obtained by the camera 200.

One of the challenges in obtaining high quality underwater images is that the lighting conditions may be challenging such as when there is low level light in the fish tank due to any combination of time of day, overcast weather and turbid water. The last condition may be particularly challenging in fish tanks where there are many fish and therefor a larger amount of feed pellets, waste and debris.

One approach to address this challenge is to increase the amount of light in the CFOV region 263. This may be done by increasing any combination of the number of light sources that are included with the camera 200 and/or increasing the intensity of the light beams generated by the light sources. However, another technical solution is to angle the generated light such that the generated light beams overlap in the CFOV region 263. In the example shown in FIG. 2E, the light source 204a generates a light beam defined by boundaries 266a and 266b and the light source 204b generates a light beam defined by boundaries 268a and 268b resulting in a region of overlapped light beams 269 which covers a large portion of the working area (CFOV region 263) of the camera 200. This results in greater illumination of the CFOV region 263 which will allow for better quality images to be obtained.

In at least one embodiment, the light sources 204a and 204b may be physically mounted at an angle to generate the overlapping light beams. In at least one embodiment, the camera 200 may include actuators that are mounted between the light sources 204a and 204b and the chassis 206 and receive control signals during use to change the angle of the light sources relative to chassis 206 to move the region of overlapped generated light based on the location of an object (e.g., fish) that is being imaged by the camera 200. The control signals may be provided by a lighting control system described in further detail below. In either embodiment, the pair of light sources at different heights along the chassis 206 (e.g., light source pair 202a and 202b and light source pair 202c and 202d) may be referred to as being laterally outwardly vertically offset with respect to the image sensors 202a and 202b since the pairs of light sources are positioned between the side edge of the chassis 202 and the image sensors 202a and 202b and also above/below the image sensors 202a and 202b.

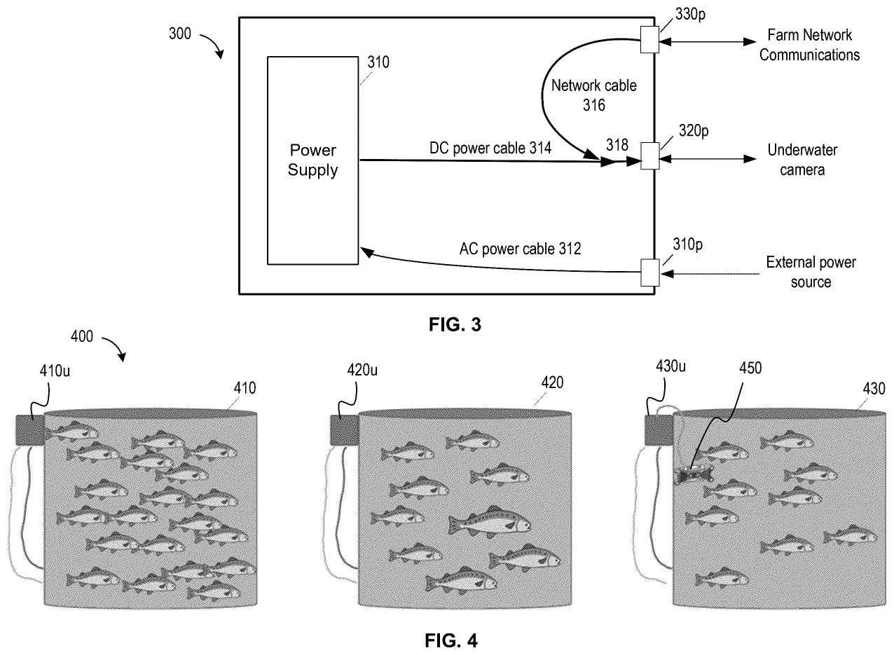

Referring now to FIG. 3, shown therein is an example embodiment of tank-side networking unit 300. The networking unit 300 is an example implementation of the networking unit 120. The networking unit 300 includes a housing (see FIG. 4) that includes a releasable mount (not shown) that facilitates mounting or attachment to a fish tank, such as fish tank 100, for example, and detachment from the fish tank so that the networking unit 300 can be used with another fish tank. For example, the releasable mount may include a bracket or flange along with apertures for receiving releasable fasteners such as screws or bolts, for example. The housing includes a board for mounting the internal hardware and is made of durable material, and may also be waterproof, to protect the internal hardware.

The networking unit 300 has a mobile design that facilitates easy transportation and installation of the networking unit 300 along with the underwater camera 200 within different fish tanks at the same or a different fish farm. An underwater camera (e.g., the underwater camera 200) is electrically connected to the networking unit 300. The networking unit 300 has hardware components and electrical wiring for providing power and Internet connectivity to the underwater camera 200. Advantageously, farmers may then effortlessly move the underwater camera from one tank to another, allowing for less hardware to be needed to perform monitoring and/or biomass measurements across various tanks within a land-based or offshore based aquaculture facility. Accordingly, the networking and power infrastructure and the light construction of the underwater cameras enables the cameras to be mobile and easily swappable from tank to tank.

The networking unit 300 includes a power supply 310 that receives, for example, 120/220V mains power via port 310p from an external power source via an AC power cable 312. The power supply 310 may be a 48V AC/DC power supply, for example. The power supply 310 includes hardware components for converting the AC power to DC power and provides DC power via a DC power cable 314 to port 320. The power supply 310 is an off the shelf customizable power supply that may be configured to provide a desired amount of power for both the processing and lighting hardware of the underwater cameras described herein. This allows for significantly more power than standard POE equipment allowing for high performance computing devices in the underwater camera to run at full capacity while ensuring enough power to drive the light sources to adequately illuminate the CFOV. The networking unit 300 also has a network port 330p for receiving network communications from a fish farm network (not shown but may include computer 140, for example), in order to provide ethernet/network connectivity to the underwater camera that is in the tank. A network cable 316 that is connected to the port 330p is then combined with the DC power cable 314 into a combined communications and power cable 318 that is connected to the port 320. Another communications and power cable is connected between the port 320 and the underwater camera. In alternative embodiments, the networking unit 300 may include other components depending on functionality needed. Also, in alternative embodiments, the networking unit 300 may have one or more alternative components with comparable functionality, such as replacing Ethernet cabling with other similar wired or wireless communication technology known to those skilled in the art. Accordingly, in an alternative embodiment the edge router 340 may have a radio for wireless communication with the external network such as the farm network.

During use, control data may be received from the farm network and routed to the underwater camera through the networking unit 300 to control certain aspects of the operation of the underwater camera such as activating the underwater camera to begin obtaining images and/or configuring certain operational parameters of the underwater camera (e.g., intensity of the generated lights). Image data and/or environmental data (which may be optional) obtained by the underwater camera may be received by the networking unit 300 and then transmitted to the farm network.

Referring now to FIG. 4, shown therein is an example embodiment of a fish farm 400 with a plurality of tanks and an underwater camera located in one tank. For example, the fish farm 400 includes a first tank 410, a second tank 420, and a third tank 430 that each have a networking unit 410u, 420u and 430u, such as network unit 300. An underwater camera 450 is located in the third tank 430. The underwater camera 450 may be, for example, the underwater camera 114, the underwater camera 200 or another underwater camera described herein. In this example, the underwater camera 450 may easily be installed in any of the tanks 410, 420 and 430. This reduces cost since one underwater camera 450 is used and may also reduce variability in accuracy of any biomass estimates or other measurements that would otherwise be due to hardware since the same underwater camera 450 is used in each tank 410, 420 and 430 at different times.

Referring now to the underwater camera 450, it should be understood that this is only for illustrative purposes and that the description below can apply to other underwater camera embodiments described herein, the underwater camera 450 comprises a robust camera design that is suited for land-based aquaculture facilities. For example, the biomass camera 450 is equipped with multiple independently controlled lights, a high-performance computation unit, and a lighting control system (e.g., an onboard adaptive lighting control system) that may be controlled in real-time, all integrated into a compact and mobile device.

The onboard adaptive lighting control system, which may be micro-controlled, may be used to dynamically adjust the intensity and/or angles (depending on the embodiment) of the light beams that are generated by the light sources based on a given fish tank's environmental conditions which may differ for various reasons during different times of the day, thereby compensating for variations in several factors such as, but not limited to, fish stocking density, fish movement (or temporary lack thereof), water clarity and/or other environmental conditions such as artificial water currents, for example. This adaptive lighting control system may improve the ability to obtain consistent and high-quality images thereby improving image data analysis accuracy.

The underwater camera 450 includes an imaging module which refers to multiple image sensors that are positioned strategically at the camera body, and are each accompanied by an independently controlled light source. Alternatively, there may be more light sources than image sensors such as for underwater camera 200. The operation of the light sources can be adjusted individually to achieve improved illumination conditions for different tanks, different water clarity scenarios and other different environmental conditions. For example, the adaptive lighting control system allows for precise customization of light intensity, light direction, and color temperature for the light generated by a given light source, resulting in more consistent and accurate image capture of fish within the tanks while also preferably not scaring away fish due to the generated light beams.

The computation unit for the underwater camera 450 may be housed within the camera body and powered by a high-speed GPU or a Neural Processing Unit (NPU), for example, enabling real-time data processing and analysis. This computation unit may be used to implement AI algorithms that may be used for adaptive lighting control, fish detection, fish tracking, biomass estimation or any combination thereof. For example, in at least one embodiment, the lighting control system of the underwater camera 450 may be linked with the computation unit, forming a dynamic and intelligent feedback loop. For example, in at least one embodiment, the lighting control system may continuously monitor one or more environmental conditions within the tank such as, but not limited to water turbidity, ambient lighting conditions, fish activity levels or any combination thereof. Based on the monitored environmental conditions, the lighting control system may automatically adjust the intensity and optionally angles of the light generated by the light source, depending on the implementation, which may be done in real-time, to improve the illumination of the tank to obtain better quality images of fish in the tank which may allow for more precise and accurate fish measurements, which may in turn improve the way fish farmers manage and improve their aquaculture operations.

Referring now to FIG. 5A, shown therein is a block diagram of an example embodiment of the electronic hardware that may be used in an underwater camera in accordance with the teachings herein. The electronic hardware includes a lighting control system 500 having power and data connections among the various components of the system 500. The lighting control system 500 has a dual processing architecture and a power and networking interface 502, a power conditioner block 504, a voltage regulator block 506, a microcontroller 508, an edge computing device 510, light source driver circuitry 512 and sensors 514a-514d. The edge computing device 510 is coupled to a camera 516 and the light source driver circuitry 512 is coupled to light sources 518a-518d. These components may be mounted on a controller board 520 or an embedded computing board 522. This is one example embodiment that corresponds to a lighting control system that can be used by the biomass camera 200. However, it should be understood that there are other embodiments for implementing the lighting control system 500 while performing the same functionality. For example, in alternative embodiments, there may be a different number of light sources and/or a different number of sensors.

The lighting control system 500 is an electronic subsystem that is placed inside a submersible camera, which may be, underwater cameras 114, 200, or 450. In a first aspect, in at least one embodiment, the lighting control system 500 may receive light control commands from a remote computer device such as a server of the fish farm network or another computing device that is in communication with the fish farm network. Alternatively, or in addition thereto, in a second aspect, in at least one embodiment, the lighting control system 500 may use algorithmic logic for adjusting the intensity and/or optionally the angle of one or more of the light sources 518a-518d depending on the implementation of the underwater camera based on one or more sensor readings (e.g., by comparing sensor readings to thresholds or ranges and taking appropriate lighting control action(s)). Alternatively, or in addition to the first and/or second aspects, in a third aspect, in at least one embodiment, the lighting control system 500 may use one or more AI models to adjust the light intensity and/or angle (optionally) of one or more of the light sources 518a-518d.

In accordance with the teachings herein, an underwater camera including the lighting control system 500 includes network connectivity which allows for remote monitoring of the performance of the lighting control system 500. An example of such remote monitoring and control is shown and discussed with reference to FIGS. 5B and 6A. In at least one embodiment, this network connectivity may allow a user to remotely adjust the operation of the lighting control system 500. In any of these embodiments, the adjustments made by and/or to the lighting control system 500 is preferably done to improve light conditions in the fish aquaculture/fish tank where the underwater camera is submerged so that images with improved image quality may be obtained which may have various benefits including enabling more accurate assessments to be made since the images have higher quality.

The lighting control system 500 includes an internal computing device (e.g., microcontroller 508) for controlling the operation of the lighting control system 500. However, the lighting control system 500 also preferably includes a high performance processor such as a GPU or an NPU by Nvidia™, Qualcom™ or Xilinx™ (e.g., edge computing device 510) which may be used to process the captured images using more complex algorithms such as one or more AI models for various purposes such as performing biomass estimates and in at least one embodiment to assess and improve image quality, an example method of which is described with respect to FIG. 6B. For example, the edge computing device 510 may use one or more AI models to assess and improve image quality.

In at least one embodiment, the various sensors 514a-514d may be used to measure environmental data which can be used to assess certain environmental conditions such as lighting, temperature and/or the like, as described herein. In at least one embodiment, the edge computing device 510 can process the measured environmental data to determine how to dynamically adjust the operation of the light sources 518a-518d to obtain better quality images.

Power and network connectivity is provided by the power and networking interface 502. The power from the power and networking interface 502 is provided to the power conditioner block 504. Data is communicated between the power and networking interface and the edge computing device 510. The power condition block 504 may include hardware for performing power conditioning (e.g., filtering). Power splitting is also generally performed as there is more than one voltage regulator in the voltage regulator block 506.

The voltage regulator block 506 typically comprises several voltage regulators depending on the power and current requirements of the various hardware components of the lighting control system 500. For example, the voltage regulator block 506 may include a first voltage regulator for providing power to the edge computing device 510 and a second voltage regulator for providing power to the microcontroller 508 and the light source driver circuitry 512. The first and second voltages regulators have operational requirements based on the power needs of the hardware devices that they provide power to. For example, the first voltage regulator may be a 12 V regulator while the second voltage regulator may be a 36 V regulator. The use of power splitting and different supply voltages allows for significantly more power compared to standard POE equipment. This higher power allows the high-performance edge computing device in the camera to run at full capacity. It also provides enough power to generate increased lighting intensity/amount to handle dark conditions in high stocking density.

The embedded computing board 522 communicates with the external network using the power and networking interface 502 where the data is routed via the controller board 520. The edge computing device 510, which may be an NVIDIA® Jetson™, for example, processes all incoming and outgoing data, and routes data to and from the microcontroller 508 over a suitable data connection such as a USB connection.

The microcontroller 508 and the controller board 502 may be implemented using suitable computing hardware such as a STM32 NUCLEO-L412KB, for example. The controller board 520 is used to route power to the embedded computing board 522 and the microcontroller 508. The microcontroller 508 is connected to the light source driver circuitry 512 and the sensors 514a-514d. In at least one embodiment, the microcontroller 508 receives instructions from the edge computing device 510 and generates and sends light control signals to the light source driver circuitry 512 to control the light intensity of the light generated by the light sources 518a-518d. The microcontroller 508 also receives sensor data provided by the sensors 514a-514d. For example, the sensors 514a-514d may be thermistors that measure temperature data such as the temperature of each of the light sources 518a-518d. The measured sensor data is sent to the edge computing device 510 for further processing, such as for adjusting the light control signals sent to the light source driver circuitry 512 if any of the light sources 518a-518d are overheating.

The light sources 518a-518d may be implemented using LEDs that receive drive signals from the light source driver circuitry 512 to generate light with a controllable intensity so that adequate illumination may be provided for a variety of tank conditions. Each of the light sources 518a-518d can be adjusted independently to each generate a light beam having a certain luminous flux, which may be in the range of about 4,000 lumens (lm) to about 20,000 lm, for example.

When the light sources 518a-518d are LEDs, the light source driver circuitry 512 can include one LED driver circuit for each LED. The LED driver circuits may be off the shelf hardware with suitable operational parameters as is known by those skilled in the art. Each of four LED driver circuits produces a pulse width modulated signal that is smoothed to avoid generating light beams which flicker in intensity as that may startle the fish. The pulse width modulation is controlled by the microcontroller 508 that may receive pulse width modulation settings from a user interface, communicatively connected over the fish farm, and may be implemented via MQTT commands. Alternatively, in at least one embodiment, the pulse width modulation settings may be determined via at least one AI model that is executed by the edge computing device 510. In at least one embodiment, each pulse width modulation setting may be retained in memory in the event of power or network loss such that the lights do not instantaneously turn off/on, as this will startle the fish. The lighting controller monitors temperature via a remote sensing resistor (e.g., sensors 514a-514d) and shuts off the lights when they overheat.

In order to obtain underwater images of fish with improved quality, the camera 516, the light sources 518a-518d, and the lighting control system 500 may preferably incorporate one or more characteristics. Firstly, it is preferable to generate the light beams such that the fish are not startled so that they move slowly and can be fully captured in a given image and do not appear blurry in the given image. Secondly, it is preferable to generate the light beams so that there is adequate lighting when the images are being obtained while reducing any glare or specular reflection which may occur at varying amounts based on the optical properties of the outer surface of the fish in the scene during image acquisition. If specular reflection/glare due to the fish scales/etc. is not reduced it might saturate the image sensors of the camera 516 and any resulting acquired images may not be useable. Furthermore, providing adequate generated light during imaging may be challenging under different aquatic conditions in the fish tank such as any combination of densely packed fish, certain weather conditions, and water turbidity.

Some of the above challenges may be addressed by increasing the illumination of the working area of the stereo camera 516 for the effective working depth of the system. Accordingly, the lighting control system 500 is implemented to provide a higher power supply voltage to the hardware elements that are used to generate the light beams. In the example embodiment, 48 Volts may be provided to the light source driver circuitry 512 while a lower power supply voltage may be provided to the computing devices (e.g., the microcontroller 508 and the edge computing device 510).

Some of the above challenges may be addressed by angling the light beams that are generated by the light sources as described earlier with respect to FIG. 2E, for example, to sufficiently illuminate the working area of the stereo camera 516 for the effective working depth of the system. For example, the light sources 518a-518d may be preferably angled inwards horizontally such that their central rays overlap at the desired working distance of the system (e.g., roughly about 100 cm) and the generated light spreads to a minimum working distance of roughly about 20 cm from the face (e.g., front surface) of the camera 516. The light sources are also preferably vertically and horizontally offset from one another such that the natural ray-spread of the generated light beams fills the imaging volume vertically and horizontally.

Generating the light beams such that they are angled may also help reduce reflection/glare during imaging. If there were only one light source or the light source was directly in between the pair of image sensors the results may be that there is more specular reflection during imaging since fish scales may act as mirrors. By angling the generated light beams, the angle of the central ray of the beams incident on a normal (e.g., incident perpendicularly) of the fish's scales has a minimal probability of resulting in the reflected ray being directed back to the image sensors which is in contrast to the situation when the light sources are in the middle or directly beside the image sensors.

In an alternative embodiment, controlling the polarization of the incoming light before imaging by the image sensors may also aid in reducing specular reflections/glare. Accordingly, in at least one embodiment polarizers are incorporated into the camera 516. For example, polarizers, such as 90° offset polarizers, may be placed between the emitted/generated light and light impingent on the image sensors which may drastically reduce specular reflection for non-central rays from the light sources 518a-518d.

Alternatively, polarization filtering may be used in combination with the angled generation light beams to reduce the glare/specular reflection. Also, since different fish may produce different specular reflection based on their scales/fish skin, the polarization filtering may be selected and/or adapted based on the fish species in the fish tank and the particular specular reflection that these fish exhibit.

Accordingly, in at least one example embodiment, the generated light beams may be non-polarized, while vertically oriented polarizers are placed in front of the light sensors. This configuration may be effective since most specular reflections may be horizontally polarized since the light sources are generally oriented to produce horizontally angled light beams.

As another example, in at least one embodiment, the light sources may be configured to generate light beams that are vertically polarized. This may then limit the amount of specular reflection intensity.

As another example, the light sources and/or camera may have adjustably oriented polarizers, and either polarization filters of the camera or polarizers used for light beam generation can be adjusted to reduce specular reflection. Processing algorithms may also be used to remove the specular reflection from the acquired images by doing differential measurements.

Some of the above challenges may be addressed by preferably operating/driving the light sources in such a way as to limit any physiological shock to the fish. For example, the light source driver circuitry 512 may be driven by a pulse width modulated signal that is smoothed so that there are no abrupt changes in light intensity of the light beams that are generated since abrupt changes in light intensity may startle the fish. As previously mentioned, pulse width modulation may be used to control light beams generated by the light sources, in which case lower frequency modulation is preferably avoided since lower frequency modulation will increase the likelihood of visible flicker in the generated light beams and therefore increases the likelihood that fish will be disturbed by the pulse modulated lighting. However, the use of high frequency pulse width modulation minimizes light flicker. For example, the pulse width modulated frequency maintained by the microcontroller 508 may be in the range of about 1 KHz to about 10 KHz, since any frequency above about 1 KHz may be considered high frequency modulation for flicker-free lighting. Capacitors may also be incorporated into the light source driver circuitry 512 and therefore coupled to the LEDs to create a smooth power signal to further reduce flicker. For example, when the light sources 512a-518d are LEDs, they may be toggled on/off in a rapid succession at the rate of:

$$PWM frequency \times Duty Cycle \% = LED toggle rate \qquad ( 1 )$$

where PWM stands for Pulse Width Modulation and the duty cycle represents the light intensity relative to maximum brightness on a scale of 0 to 1. This provides light intensity adjustment and regulation abilities. The duty cycle used can be multiples of 0.01 in the range of 0 to 1 taking into account a safety buffer. For example, the duty cycle value can be converted to the actual light intensity value of the generated light beam as an approximate percentage from the minimum drive to the maximum drive of the light source with a safety buffer so that the light source is not driven at maximum capacity. If LEDs are used that have a maximum of about 4,000 lm, then the duty cycle range converts to a light intensity output in a range from 0 lm to about 4,000 lm in steps of 40 lm per light source. It should be noted that the relationship is not exactly linear in practice but can be assumed for the purposes of controlling light intensity. Furthermore, it should be noted that the ambient temperature of the light source may have an effect on the generated light intensity and this can be determined for the data sheets provided by the manufacturer of the light sources.

Accordingly, during operation, a pin on the microcontroller 508 may receive a “high” signal when the LED sources are toggled on to complete the light source driver circuitry 512 and turn on the light sources 512a-512d. When capacitors are used/included in the light source driver circuitry 512, one capacitor is preferably used per light source and these capacitors provide energy between each pulse to provide a smooth transition between the high power and no power states that would otherwise exist due to the pulsed on/off modulation. This may be achieved by draining the capacitors of their energy to the respective light source in between each pulse in the light control signals.

Some of the above challenges may be addressed by preferably making any changes to the intensity of the generated light beams in a gradual manner when the light intensity must be changed (e.g., when a light source is first activated, when the light source is to be deactivated, or when a change in light intensity is received based on instructions from the user or from the operation of an automated algorithm). This is because abrupt changes in the intensity of the generated light beams can startle fish. Accordingly, when a light setting is changed or when the camera is first introduced into a fish tank the lighting control system may be configured to ramp up the generated light at a given rate of change (e.g., changes the light intensity by a certain percent over time) from the current lighting state to the final lighting state (where a lighting state refers to the light intensity for the generated light beams). For example, if the light sources are turned on after being inactive, the intensity of the light output may be ramped from 0% to 70% of overall capacity at a rate of 5% every 15 minutes until reaching the desired 70% output light setting. For example, the light intensity may be changed in an amount of about 1% to about 50% of overall light intensity capacity about every 30 seconds until the light intensity has been changed for about 15 minutes. As another example, if any of the light sources are determined to be overheating based on sensor readings, the microcontroller 508 may be configured, vis executing software, to gradually reduce the light output from the overheated light source. Accordingly, when a light intensity change request is received by the microcontroller 508, the difference in duty cycle between the current state of the light intensity of the light source and the requested light intensity is calculated to find the number of “steps” to take in order to make a smooth transition from the current light intensity to the desired light intensity. The duty cycle may then be incremented up or down, such as by a value of 0.01, for example, as explained previously, until the desired light intensity is reached.

In at least one embodiment, the edge computing device 510 may execute software including one or more AI models that may be used to generate light control signals that can be used to control the light sources 518a-518d to provide improved lighting conditions in the aquaculture tank for obtaining underwater images. For example, employing software automation for the lighting control system 500 may reduce the frequency of user intervention. Examples of these AI models are described in further detail below.

Alternatively, or in addition thereto, in at least one embodiment the user may have the option to manually adjust the operation of the lighting control system 500 to meet certain needs. This may be done remotely, such as via computer 140 or another remote device, through a software application that may operate in real-time to implement two-way communication between the user and the lighting control system 500. The software application may have one or more GUIs that allows the user to monitor and control the lighting control system 500. Accordingly, in at least one embodiment, the systems 100 and 500 as well as the various underwater camera embodiments implement user-controlled dynamic off-center lighting for improving the quality of underwater images allowing for more accurate underwater biomass estimation.

In at least one embodiment, the edge computing device 510 is configured to receive commands over the network via the power and networking interface 502 and then process the commands in order to determine instructions that are provided to the microcontroller 508 for controlling the operation of the light source driver circuitry 512 and in turn the light beams generated by the light sources 518a-518d. For example, the received commands may be from user input by a user at the fish farm network or connected remotely over a cloud network. Alternatively, the edge computing device 510 may automatically generate the instructions by running a lighting control algorithm which may use an AI model.

The instructions may then be sent to the microcontroller 508. If the instructions consist of a request for information from the microcontroller 508, the requested information is sent via a USB connection (or other suitable communication connection) to the edge computing device 510 and in some cases may be sent back to the user at the fish farm or over the cloud network.

In these various embodiments, regardless of whether commands are user generated or software generated, controller commands may be sent to and from the camera 516 using an appropriate communication protocol such as, for example, the Internet using Message Queuing Telemetry Transport (MQTT) protocol. For example, changes to the settings for the lighting control system 500 in one of the GUIs may trigger a corresponding command to be sent through an application programming interface (API) using the MQTT protocol. Once commands are received at the camera 516, they may be further processed as described herein.

In at least one embodiment, the lighting control program that is executed by the edge computing device 510 may process real-time images from the camera feed provided by the camera 516 and optionally sensor data from one or more sensors to determine environmental conditions which may necessitate a change in lighting intensity, such as water turbidity, fish stocking density, ambient lighting conditions, concentration of floating particulate matter or any combination thereof. If the control program detects that performance can be improved by a lighting intensity change, the control program is used to determine the desired light intensity and desired image quality, and then send corresponding commands/instructions to the camera 516 and/or the light source driver circuitry 512.

In at least one embodiment, the edge computing device 510 is configured to receive commands using a protocol, such as the universal asynchronous receiver/transmitter (UART) protocol, which allows for instantaneous processing and execution of instructions. For example, if the edge computing device 510 receives a light intensity change request, perhaps from a remote user, the edge computing device 510 may be configured to interpret this request as a percentage change with respect to the maximum brightness of the light generated by the light sources 514a-514d. The edge computing device 510 may then generate and provide instructions to the microcontroller 508 for outputting one or more control signals comprising a square-wave signal with a PWM duty cycle that corresponds to the brightness percentage. The microcontroller 508 sends the control signal(s) to the light source driver circuitry 512.

Referring now to FIG. 5B, shown therein is an image of an example embodiment of a light control graphical user interface (GUI) 550 which may be used by a user at a fish farm or over the cloud for monitoring images obtained from an underwater camera as well as to adjust camera and light control parameters. The light control GUI 550 includes an image panel 552 for showing an image obtained by the underwater camera, an image acquisition date 554 and a camera identifier 556. The GUI 550 also includes an input option 558 for the user to select whether to view an image obtained from a single image sensor or a stereoscopic image based on images obtained from both images sensors at the same time. The GUI 550 includes a save input option if the user would like to save the image displayed in the image panel 552 to a file or database.

The GUI 550 also includes camera imaging input options to control various imaging parameters (which are grouped together as basic camera settings 564 or advanced camera settings 566) and lighting control input options 568 for various light control parameters. The user may use control input option 562 to select whether preset values should be used for the camera and lighting control parameters or whether to create and use custom lighting control parameters. For the former option, the user may select from several predefined camera and lighting control settings that are saved in memory and may be applicable depending on certain environmental conditions such as time of day, sunlight conditions, number of fish in the fish tank, etc. For the latter option, the user may prefer to adjust the camera and/or lighting parameters based on their preference or to adjust image quality for the obtained images to result in better analytical performance such as when performing biomass estimates. The user may then save their custom defined settings using save button 570. The user then decides which control values to send to the underwater camera. The control values are sent to the edge computing device 510 whenever a change in lighting control is made.

For example, for basic camera settings 564, the user may provide values for any combination of an exposure control input, a contrast control input and a brightness control input. As another example, for advanced camera settings, the user may provide values for any combination of a gain control input, a gamma control input, a saturation control input, a white balance control input, a hue control input and a sharpness control input. As another example, for light control settings, the user may provide values for intensity control for each light source independently. In at least one embodiment, although not shown, the user may provide input values for ramp on control and ramp off control which controls the rate at which the light sources increase the light intensity of the generated light beams when the light sources are first turned on and the rate at which the light sources decrease the light intensity of the generated light beams when the light sources are turned off. In addition, or in an alternative thereto, although not shown, in at least one embodiment, the user may provide input values for maximum and/or minimum light intensities for each light source during operation. In addition, or in alternative thereto, although not shown, in at least one embodiment, the user may provide input values for turn on and turn off times to set the times of the day during which the light sources are on and off.

While FIG. 5B shows one control GUI, in at least one embodiment there may be several control GUIs that correspond to different underwater cameras and these control GUIs may all be shown on the same display which allows the user to monitor and control several different underwater cameras, such as for several different tanks, at the same time or at separate times. In such embodiments, in an alternative, the user may select one of the control GUIs which may then be shown by itself on a display.

Referring now to FIG. 6A, shown therein is a flow chart diagram of an example embodiment of a lighting control method 600. At step 602, the user sets up camera details when a camera has been set up in a new tank. The user may enter a tank ID (identifier) in which the camera is located. The user may also specify information about the fish in a tank such as any combination of the species of fish, the number of fish, and the maturity of the fish in the fish tank, for example. The user may also specify information about the camera such as any combination of the type of camera, and when the camera was first commissioned, for example. The information specified by the user may be stored in a configuration file or in a database. Step 602 may be optional in cases where no new cameras have been deployed and need to be setup in the system.

At step 604, the user selects a control GUI for an underwater camera that the user wishes to monitor and/or control. The control GUI may be selected from several control GUIs where each control GUI is associated with a unique underwater camera.

At step 606, the user may view one or more images for the selected underwater camera and decide to adjust one of more parameters which might be any combination of camera parameters and/or lighting control parameters, examples of which were provided with the description of FIG. 5B.

At step 608, if the user made changes to least one of the camera parameters and lighting control parameters, commands are sent to the underwater camera through the network connection. The commands are then processed by the edge computing unit 510 for generating instructions that are used to make corresponding adjustments for the camera 516 or the lighting hardware.

At step 610, once the camera and/or lighting control parameters are adjusted the user may proceed with processing the images that are obtained by the underwater camera. For example, the processing may involve performing biomass estimates on the images.

Referring now to FIG. 6B, shown therein is a flow chart diagram of an example embodiment of a lighting control method 650 that may be used with one of the underwater camera embodiments described herein and performed using at least one processor of these embodiments. The lighting control method 650 is based on assessing image quality to determine whether the acquired images are acceptable for further use, such as in biomass estimation, or if one or more camera and/or lighting control parameters need to be adjusted to improve image quality for more accurate downstream processing. If camera and/or lighting control parameters need to be adjusted, then one or more input features may be analyzed along with the acquired image to general control instructions for making the adjustments. For example, the input features may be determined on any combination of sensor data (e.g., of underwater imaging environmental data), one or more image metrics (e.g., image score) and current camera and/or lighting control parameters. In at least one embodiment, the image metrics may include any combination of measures based on amount of light/darkness, average pixel intensity, histogram spread, one or more color balance metrics, blur and contrast, for example. In at least one embodiment, the underwater imaging environmental data may be based on sensor data as well as user input. The processing and/or analysis steps of the lighting control method 650 may be performed by at least one processor such as, for example, the edge computing device 510.

At step 652, the method 650 involves capturing an image using one of the biomass cameras described herein. This image is referred to as a current image. The image is created from image data obtained by the stereoscopic image sensors as is known by those skilled in the art.

At step 654, the method 600 involves assessing image quality of the current image. This may involve performing one or more image processing algorithms on the pixel image data. The image processing algorithms may involve performing one or more measurements on the current image to determine image quality such as any combination of amount of light/darkness, average pixel intensity, histogram spread, one or more color balance metrics, blur, sharpness, contrast, noise, color accuracy, and dynamic range. If multiple image quality measurements are made, then they may be combined to obtain an image quality score for the current image. Alternatively, the current image may be processed by an image quality ML model that is trained using a training set that includes training images having acceptable image quality (with respect to downstream processing such as biomass estimation) and training images having unacceptable image quality with respect to downstream processing. The ML model may be an AI model that is implemented using a neural network, a convolutional neural network or a transformer, for example. The output of the ML model may be an image quality score. In either of these implementations, the image quality score may be determined in such a way that it represents whether accurate downstream image analysis may be performed on the current image for certain purposes such as performing biomass estimates.

At step 656, the method 650 determines whether the image quality is acceptable such that further downstream (e.g., later performed) analysis may be performed more accurately on the current image for certain purposes, such as estimating various aspects of biomass, for example. This may involve comparing the image quality score determined at step 654 to an image quality score threshold, for example. The image quality score threshold may be determined empirically based on images that were able to be accurately processed for certain downstream purposes such as biomass estimation.

If the determination is true, the method 650 then proceeds to step 658 where the further (e.g., downstream) pipeline processing and analysis is done. If the determination at step 656 if false, then the method 650 proceeds to step 662. At this step further processing may be done to enhance images for downstream analysis, such as any combination of a) noise reduction using Gaussian filters or denoising autoencoders, for example, b) histogram equalization to improve contrast, and c) color correction to address water-induced distortions.

In parallel with the processing done at steps 654 to 656, various environmental data may be obtained at step 660. For example, the underwater camera may include different types of sensors and receive user inputs for obtaining environmental data including, but not limited to, any combination of RGB data, tank location data, stocking density data, time data, temperature data, current lighting condition data, current camera parameter values, and current lighting control parameters. Some of the environmental data may be obtained at rates that are higher or lower than the image frame rate (e.g., image capture rate of the biomass camera) depending on how quickly the environmental conditions may change and the nature of the subsequent processing of the environmental data at step 662. For example, sampling rates may be at least set at the Nyquist rate or a higher rate depending on whether frequency analysis is performed on some of the environmental data. However, for certain environmental parameters which change much more slowly, previously stored environmental data values for the current tank that the underwater camera is installed in may be used.

At step 662, the method 600 comprises determining control instructions for changing at least one camera parameter value and/or at least one light control parameter so that the next image that is captured has a better image quality than the current image. This may be determined in a variety of ways.

For example, in at least one embodiment, step 662 may involve applying one or more control instruction recommendation machine learning (ML) models, which may be implemented Artificial Intelligence (AI) models, which employ machine learning algorithms for determining the control instructions. For example, machine learning may be implemented using (a) classical approaches, (b) learned techniques, or (c) auto-encoders (e.g., image quality based on pre-existing knowledge). Accordingly, an ML model may be used in step 662 where the ML model may use regression or classification or the ML model may be an AI model that includes a neural network, a convolutional neural network, a transformer, or an autoencoder model. Input features that may be provided to the ML model may be based on image metrics and environmental measures/data. For example, image metrics include any combination of measures based on amount of light/darkness, average pixel intensity, histogram spread, one or more color balance metrics, blur and contrast. Such image metric features may aid in detecting underexposure or overexposure via the average pixel intensity and histogram spread, while low local contrast and edge sharpness can used to determine if there is insufficient lighting or excessive scattering. Additionally, color balance metrics can highlight dominance of certain channels, such as the blue color channel due to certain water conditions, while specular reflections and backscatter metrics can reveal lighting issues such as glare or improper light direction. Other image-based metrics that may be used as an input feature may be based on edge detection. Accordingly, input features based on these metrics may provide the ML models with information to if there is poor image quality and what it may be due to in order to generate lighting control instructions to then improve the image quality of any subsequently obtained images after the light control changes have been implemented. Environmental data may include any combination of fish stocking density data, time data, temperature data, current lighting condition data.

The ML model(s) used at step 662 are trained using training data comprising images that are labelled according to their image quality assessment, as well as sensor data and camera and lighting control parameter values at the time the training images were captured. The training data set for training the ML models for determining image quality and control instructions may evolve over time as new training images are added. Accordingly, the ML models can be updated (e.g., retrained) over time as the training data set is updated. For example, if one or more AI models are used, reinforcement learning algorithms including, but not limited to, Q-Learning, Deep Q Networks, Long-Short Term Memory (LSTM) or, transformers, may be used to train the AI models used in steps 654 and 662. In addition, in at least one embodiment, online learning may also be used during training so that the AI models can be adapted over time as tank conditions/environmental parameters change. Timestamp data and other relevant information may also be provided to enable the online learning.

In at least one embodiment, the method 650 may also include an active feedback step (not shown) for enabling the continuous adaptation of the reinforcement learning used to train and update the AI models in order to adaptively provide appropriate values for the control instructions in response to dynamic environmental changes such as, but not limited to, placing the underwater camera in a new tank, changes in turbidity of the aquaculture, and changes in fish stocking density, for example, thereby improving the image quality of subsequently acquired images. The implementation of the feedback step may depend on the underlying AI model architectures that are used and the feedback step may include using, but is not limited to, online learning, experience replay, back propagation, and attention mechanism, for example.

At step 664, the method 600 involves adjusting one or more parameters of the lighting control system and/or the camera for improving image quality for a subsequently captured image. For example, the control instructions determined at step 662 may include new values for light intensity control, direction control, polarization control, spectral control, camera control, or any combination thereof.

For example, the value for light intensity control may be processed by the edge computing device 510 to generate instructions that are sent to the microcontroller 508 for adjusting the light control signal that is sent to the light source driver circuitry 512 to change the light intensity of the light generated by one or more of the light sources 518a-518d.

In another example, in embodiments in which the camera has light source actuators, then the direction control value may be processed by the edge computing device 510 to generate instructions that are sent to the microcontroller 508 for sending an actuator control signal to one or more actuators to adjust an orientation of the corresponding light sources which in turn controls an angle of the light beam generated by the corresponding light sources 518a-518d.

In another example, in embodiments in which the camera can perform polarization filtering, values for polarization control may be sent to the edge computing device 510 which in turn sends instructions to a polarization controller of the camera 516 to apply certain polarization filtering to incoming light prior to the incoming light reaching the image sensors of the camera 516. For example, the polarization filters may be located in front of the lenses of the image sensors of the camera 516 and controlled to attenuate light intensity of the incoming light, reduce the influence of reflections in the incoming light, reduce glare in the incoming light, and the like. For example, the polarization filters may be controlled to apply linear polarization and/or circular polarization. This is advantageous since applying polarization filtering to the incoming light to the image sensors of the camera can help reduce glare/specular reflections from any shiny fish in the scene (e.g., field of view or combined field of view) thereby improving image quality and processing in the pipeline such as detection rate of fishes in the acquired images.

In another example, in at least one embodiment, values for spectral control may be adjusted and sent to the edge computing device 510 which in turn sends instructions to a spectral controller of the camera 516 such that certain wavelengths of the incoming light may be reduced or amplified by performing filtering. Some fish may have higher/lower imaging qualities depending on the wavelength of light the fish are being illuminated with where the wavelength may vary from the Ultraviolet (UV) range to the Infrared (IR) range.

In another example, in at least one embodiment, values for various camera control parameters may be adjusted and sent to the edge computing device 510 which in turn sends instructions to a camera controller to improve image quality by adjusting one or more settings of the camera 516. For example, these settings may include, but are not limited to, any combination of exposure rate, brightness, contrast, gain, color/white balance, gamma, hue, saturation, sharpness, and capture rate.

One of the challenges in obtaining underwater images that may be used for biomass estimation relates to the interaction of the fish with the underwater camera such as the position of a fish relative to the underwater camera during imaging. For example,

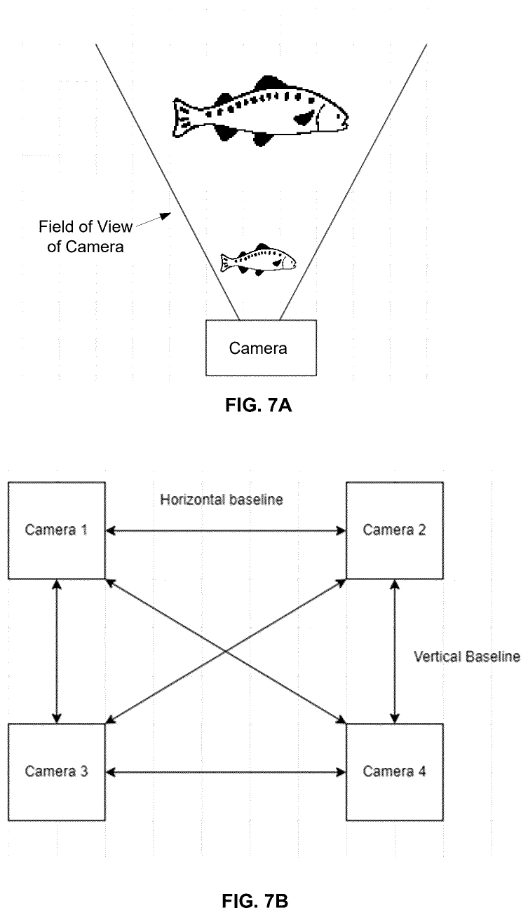

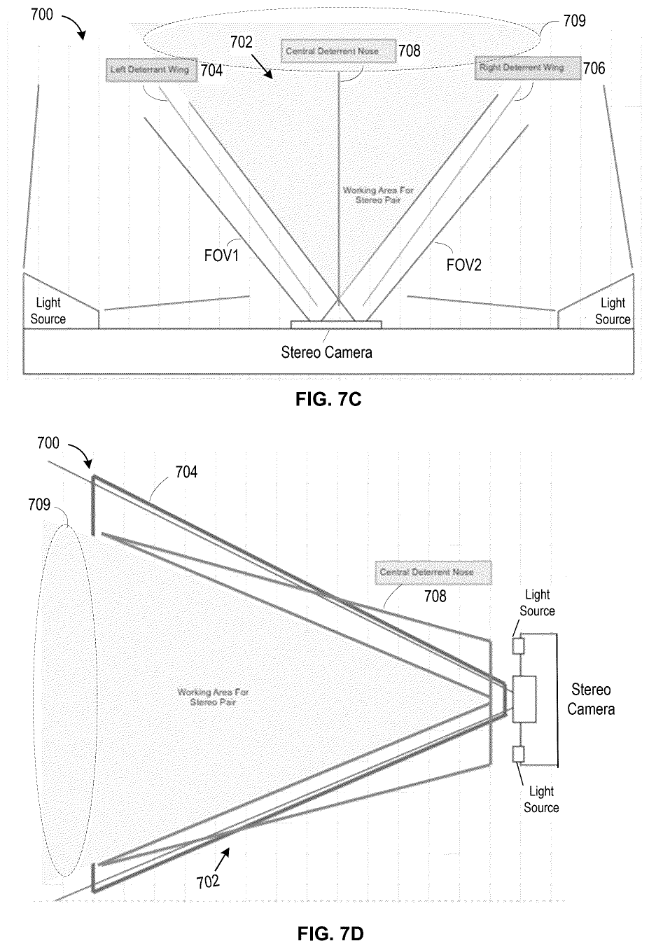

FIG. 7A shows an example of the problem of object size and position determination relative to a camera, which is a problem of scale. This problem becomes more challenging in land-based fish farms where one or more fish may tend to stay in a position close to the underwater camera and where larger fish may not be totally captured in the FOV of the underwater camera for certain images which makes it difficult to obtain biomass estimates for those images. However, the inventors have determined innovative solutions to these problems based on the physical setup of the image sensors and underwater camera and/or operation of the lighting control system.

Firstly, one technique for distinguishing between small objects that are close to an underwater camera and larger objects that are further away from the underwater camera may involve converting pixel locations (and hence pixel-determined dimensions) to real-world coordinates. This may also be done for other objects of interest. This conversion from pixel to real-world coordinates may be performed using algorithms known to those skilled in the art.

Another way to deal with the challenge of scale in biomass estimation may be to use multiple image sensors or multiple cameras that each have one image sensor. For example, referring now to FIG. 7B, shown therein is an example of using a multi-camera array (or multi-image sensor array) that may be used to determine object size and position relative for an object in the combined FOV to the multi-camera array. The difference in pixel-space between two images captured between two cameras offset in the physical world may be used, which is analogous to how humans perceive depth. The camera offset is referred to as a baseline. In the case of two horizontally offset image sensors, e.g., a horizontal stereo camera, there is a physical separation between the two cameras providing a left image and a right image. Likewise, for the case of two vertically offset image sensors, e.g., a vertical stereo camera, there is a physical separation such that top and bottom images are obtained. This may also be applied to image sensors that are physically separated such that they are diagonally offset from one another. Accordingly, a multi-camera array provides as many viewpoints as there are physically separated image sensors/cameras each with their own corresponding image pairs, as shown in FIG. 7B, that a stereo algorithm may process.

The physically offset image sensors pairs provide different viewpoints of the object which can be compared against each other and the disparity (or difference in pixel space between the images for the object) can be used to calculate the absolute depth between the object and the image sensors according to equation (2).

$$z = ( baseline * calibrated focal length ) / disparity \qquad ( 2 )$$

where: baseline is the distance between the two image sensors, the calibrated focal length is the effective focal length (in pixel space) of the calibrated camera system (e.g., where the viewpoints for each image sensor overlap) and disparity is the difference in absolute pixel location between two matching points/objects in a scene (e.g., if in one image from one image sensor the tip of an arrow is at pixel y1=100 and in a second image from a second image sensor the tip of the arrow is at pixel y2=150 then the disparity is y2−y1=50). If the object were closer to the image sensors, then the disparity increases and is greater, while if the object is further away from the image sensors, then the disparity decreases and is lower.

In order for such stereo algorithms to provide accurate results for any measurements made for the object of interest (e.g., in calculating disparity), the object of interest is preferably clearly visible in the FOV of both image sensors in a stereo pair. Accordingly, in the case of a horizontal image sensor setup, the object of interest needs to be seen in both the right and left FOV such as CFOV 263 for underwater camera 200 (e.g., see FIG. 2E). The issue of clearly seeing objects of interest in the combined FOVs of image sensors in a stereo pair is particularly challenging when the objects of interest are marine life in an aquaculture tank especially for land-based aquaculture tanks for a variety of reasons.

Firstly, artificial currents are used in aquaculture tanks to mimic the ocean environment. The fish, such as salmon, in a fish tank swim against these currents, with the strong fish tending to congregate in the areas of stronger flow in a fish tank and the weaker fish seeking out areas with less current. The current tends to be weaker near the edge of the tank. Similarly, when anything creates a disturbance to the flow, it can create an area of low-current which the smaller fish tend to seek out.

Secondly, the presence of underwater cameras in a fish tank also influences the behaviour of the fish which may make it challenging to image the fish (e.g., the objects of interest). For example, once the fish have acclimatized to the presence of an underwater camera, the smaller fish tend to be attracted to the underwater camera and position themselves in front of the camera for long periods of time which at best causes a tendency towards obtaining more images of smaller fish which results in sampling smaller fish more often when performing biomass estimates which results in a small fish bias and a skewed population measurement towards smaller fish or at worst results in reduced or no sampling for biomass estimates at all since the same fish may remain in front of the underwater camera and may not move for long periods of time.

In order to aid with improving image quality and improving the behaviour of the fish, to improve downstream processing of the images such as the ability to obtain biomass estimates, for certain fish tanks with certain types of fish, the inventors have determined that it may be beneficial to incorporate a physical barrier to the underwater camera to influence the behaviour of the fish. The physical barrier may be referred to as a fish deterrent.

In a first aspect, in at least one embodiment, the fish deterrent may be structured to keep larger fish far enough away from the image sensors so that larger fish may fit within the CFOV/working area of a stereo camera instead of passing too closely to the image sensors of the underwater camera and not fully fitting within the CFOV (which results in images of portions of the fish rather than the entirety of the fish).

In a second aspect, in at least one embodiment, the fish deterrent may be structured to prevent smaller fish from remaining stationary in the CFOV. For example, the fish deterrent may be structured to reduce the area/space for smaller fish to congregate in front of the underwater camera.

In a third aspect, in at least one embodiment, the fish determent may be structured to avoid reducing (e.g., by blocking) the CFOV of the stereo camera. For example, the fish deterrent may be structured to use thin components that are optionally transparent in the CFOV.

In a fourth aspect, in at least one embodiment, the fish deterrent may be structured to reduce any effect on the hydrodynamics in the tank. This may be achieved by using porous structures for the fish deterrent to avoid creating eddy currents or putting stress/strain on the ecosystem system while still making the fish deterrent structure strong enough so that it cannot be chewed by the fish and also using materials that are as chemically inert as possible so as not to react with the potentially saline water or leach chemicals into the water. This may be achieved by including meshing in the fish deterrent and making the frame of the deterrent using a chemically inert material.

In a fifth aspect, in at least one embodiment, the fish deterrent is preferably structured so that it does not interfere with the ability to light the scene with the light beams generated by the underwater camera's light sources (e.g., the fish deterrent may be structured to reduce shadows, glare and/or specular reflections). Shadows in the acquired images may reduce image quality and may create difficulties for any downstream pipeline processing.

In various embodiments, any of the first to fifth aspects may be combined.

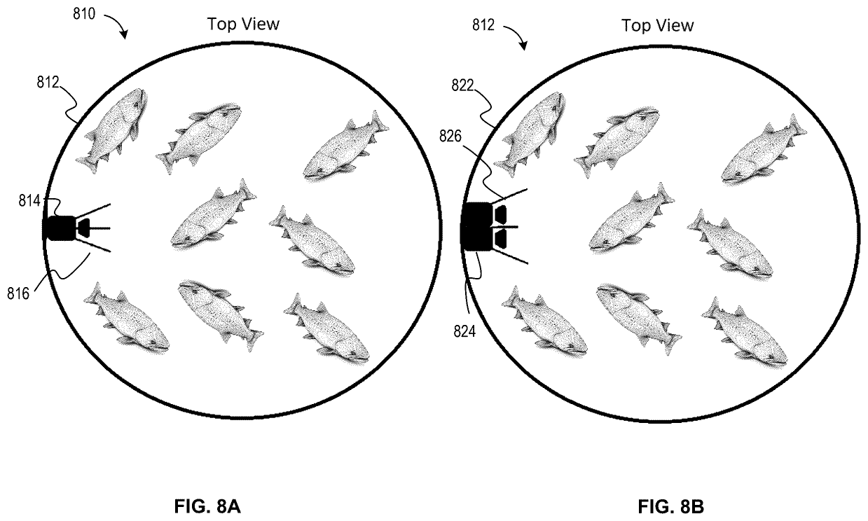

Referring now to FIGS. 7C and 7D, shown therein are top and side schematic views of an example embodiment of an underwater camera 700 with stereoscopic image sensors along with a fish deterrent 702. The fish deterrent 702, which may also be referred to as a passive fish deterrent, comprises two side members 704 and 706 and an optional central member 708. The two side members 704 and 706 may be referred to as left and right deterrent wings, respectively, and the central member 708 may be referred to as a nose deterrent or central deterrent member. The side members 704 and 706 may preferably have a trapezoidal or triangular shape while the central member 708 preferably has an arcuate or arciform shape (e.g., a horseshoe, crescent moon or arched shape). The fish deterrent 702 may be used with a variety of camera setups including multiple cameras/multi-camera arrays (e.g., see FIG. 8B).

The outer deterrent members 704 and 706 define an exclusion area that is structured to ensure that larger fish pass far enough in front of the image sensors of the camera 700 so as to be entirely contained within the CFOV/working area 709 of the stereopair of image sensors where the region 709 is just beyond the deterrent members 704-708. In at least one embodiment, the central deterrent member 708, which may also be referred to as an inner vertically-split divider, may also be used to provide a physical barrier that acts as a deterrent to prevent smaller fish from staying at the front of the working area of the image sensors.

Accordingly, the fish deterrent 702 has tapered netted/meshed sidewalls, along with an open face and open top and bottom area. The inventors have determined that using a hybrid approach to the fish deterrent results in desired behavior of the fish, i.e., not using a full cage around the underwater camera for the hybrid approach, thereby keeping larger fishes further away from the sensors while allowing smaller fish to swim closer to the deterrent prevents fish crowding in front of the underwater camera. While there may be a risk of smaller fish swimming directly in front of the image sensors of the underwater camera 700, this behaviour may be mitigated by using the central deterrent member 708.

The dimensions of the deterrent members 704, 706 and 708 are preferably based on the effective working area of the stereo camera which is effectively determined by the stereo camera's baseline and the fields of view of both of the individual image sensors (as shown and described with respect to FIG. 2E) as well as for preventing shadows in the CFOV. For example, based on the amount of vertical offset of the pairs of light sources on the left and right side of the underwater camera 700 combined with the amount of angle used for generating the angled light beams horizontally and vertically inwards towards the working area, the dimensions and placement of the deterrent side members 704 and 706 are selected so that the generated offset lighting from one pair of upper and lower light sources at one side of the camera which may cause shadows due to a deterrent member are compensated for (through light wave superposition) by generating offset lighting from the other upper and lower pair of light sources at the other side of the camera, such that there are no or very little shadows being cast beyond the length of the deterrent members. The overall dimensions of the deterrents and angles of the light sources are selected based on the size of the fish desired to be imaged within the FOV 709 that is just beyond the deterrent members 704-708.

Also, in embodiments with the central deterrent member 708, the cutout of the central deterrent member 708 may be dimensioned to follow the vertical FOV field of view of the stereo camera setup. Accordingly, the central deterrent member 708 is structured to not impede in the combined FOV of the stereo camera but still prevent smaller fish from remaining stationary too close to the stereo camera.

The deterrent members 704, 706 and 708 may also be preferably made using materials that are non-solid (e.g., are porous) such that there is little effect on current since smaller fish would otherwise tend to congregate in front of the camera if there was an area of lower current strength there which might be created if solid walls were used for the deterrent sidewalls 704, 706 or the central deterrent member 708. Accordingly, the fish deterrent is designed to take the natural behaviour of fish into account.

It should be noted that the fish deterrents are generally easily deployable and may be integrated on existing underwater cameras. The fish deterrents are generally passive, in that they are not necessarily constantly actively moveable. The fish deterrents described herein generally extend along the imaging direction away from the plane of the image sensors and somewhat along a boundary of the CFOV/working area of the image sensors.

Referring now to FIGS. 8A-8B, shown therein are top views of a fish farm tank with example embodiments of an underwater camera attached to different fish deterrents. In a first setup 810 shown in FIG. 8A, a fish tank 812 has disposed therein a single camera 814 for underwater imaging and a fish deterrent 816 is installed/attached on, or adjacent to, the single camera 814. While the fish deterrents have been described for use with stereo cameras, the fish deterrents may be used with non-stereo cameras 814 and positioned with respect to the single FOV of the camera 814. In a second setup 320 shown in FIG. 8B, a fish tank 822 has disposed therein a stereo camera 824 for underwater imaging. A fish deterrent 826 is installed on/attached to the stereo camera 824 as previously described for when there are two image sensors.

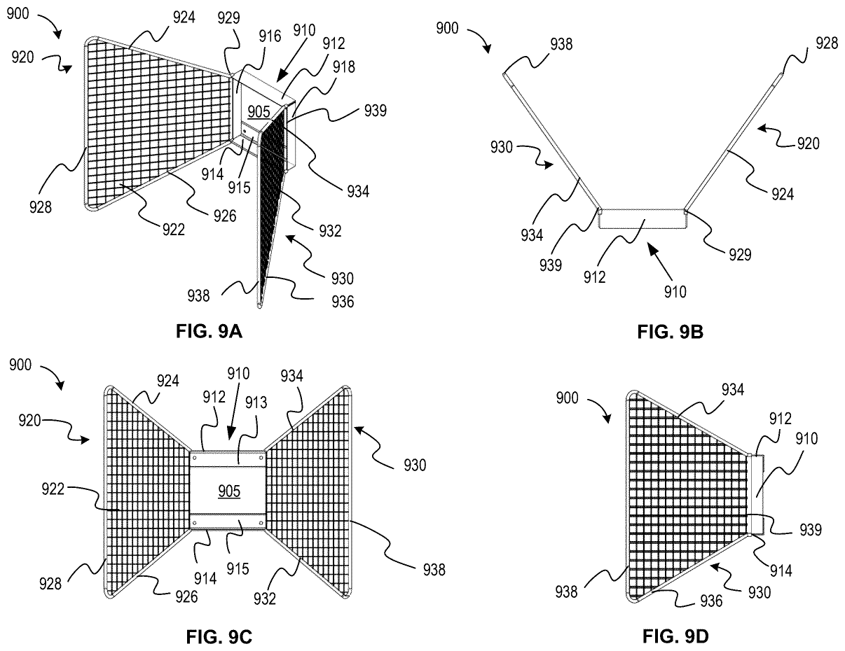

Referring now to FIGS. 9A-9D, shown therein are perspective, top, front and side views, respectively, of an example embodiment of a fish deterrent 900 that is not currently attached to a camera. The fish deterrent 900 has an attachment element that is an attachment frame 910 (i.e., mount or mounting frame) defined by a top wall 912, a bottom wall 914, a left sidewall 916, and a right sidewall 918 as well as upper and lower mounting plates 913 and 915 at the rear edges of the walls 912, 914, 916 and 918. The walls 912 to 918 and plates 913 and 915 are spaced apart from one another to define an open space 905. It should be noted that each of the walls 912, 914, 916 and 918 are designated by location for convenience only, and that they may be alternatively referred to as first, second, third and fourth walls, respectively. The fish deterrent 900 also has side barriers (i.e. deterrent members) including a left barrier 920 (e.g., left wing deterrent) and a right barrier 930 (e.g., right wing deterrent) that extend outwardly from the attachment frame 910 that are attached to the left and ride sidewalls 916 and 918, respectively. The fish deterrent 900 is mountable to an underwater camera. Fasteners (e.g., screws) may be used to attach the mounting plates 913 and 915 to a housing of an underwater camera such as the support plate 206 of underwater camera 200, for example.

The left barrier 920 (e.g., first barrier) includes a frame for a sidewall 922 that is made using a mesh. The frame may be planar and has top and bottom segments 924 and 926, and front and rear segments 928 and 929. It should be noted that each of the segments 924, 926, 928 and 929 are designated a location for convenience only, and that they may be alternatively referred to as first, second, third and fourth segments, respectively. The segments may be formed using bars or rods that are attached to one another or one long bar or rod that is bent and the ends connected to form the segments 924 to 929. The segments 924 to 929 are made using a sturdy material that does not easily corrode in water. Accordingly, the segments 924 to 929 may be made using an appropriate stainless steel, aluminum, brass, bronze, or a sturdy material that has an anti-corrosion coating. The material must be sturdy enough so that it is not easily bent by the artificial currents in the fish tank or if it is struck by a fish.

The left barrier 920 may have a trapezoidal shape in which the rear segment 929 is shorter than the front segment 928 such that the top (i.e., upper) and bottom (i.e., lower) segments are angled upwards and downwards respectively. This shape allows for the rear segment 929 of the left barrier 920 to be more effectively attached to the left sidewall 916 of the attachment frame 910 since they have the same dimensions. The trapezoidal shape is also used to minimally impact the behavior of fish in the fish tank (e.g., by reducing the effect of the surface area of the deterrent on water flow-volume) while also sufficiently covering the working area of the stereo camera. However, other configurations of the sidewall 922 may be used that have other shapes.

The right barrier 930 (e.g., second barrier) has a similar structure, components and shape as the first barrier 920 and may be made using the same materials as the first barrier 920. Accordingly, the second barrier 930 includes a frame for a sidewall 924 that is made using mesh. The frame has top and bottom segments 934 and 936, and front and rear segments 938 and 939 which may also be referred to as first, second, third and fourth segments 932. The rear segment 939 is attached to the right sidewall 918 of the attachment frame 910.

The top segments 924, 934 and bottom segments 926, 936 extend outwardly from the attachment frame 910 such that the front segments 928, 938 are a sufficient distance away from the attachment frame 910 (e.g., in the range of about several hundred mm such as about 250 mm to about 1,000 mm, for example, is determined based on the size of the underwater camera and field of view). When a central deterrent member is used, it may be dimensioned to extend away from the camera by a similar amount as the outer deterrent members to form an exclusion region where the fish are not meant to congregate. The top segments 924, 934 and bottom segments 926, 936 also extend at a horizontal angle to the attachment frame so that the front segments 928, 938 have a sufficient distance between them to cover the CFOV at a certain distance away from the image sensors (e.g., about 250 mm to about 2,000 mm). The front segments 928, 938 may have a height that is selected to be slightly larger than the height of the CFOV at the position of the front segments 928, 938. For example, the height of the front segments 928, 938 may range from about 100 mm to about 3,000 mm. The extent of the barriers 920, 930 (e.g., length or longitudinal extent which is the approximate distance of the front segments from the image sensors) may vary from about 150 mm to about 1,000 mm. Again, as noted above, the dimensions of the deterrent members may vary for different embodiments and are generally based on the dimensions of the CFOV of the camera and size of the fish that are being imaged.

The sidewalls 922, 932 of the barriers 920, 930 may be made of a mesh netting such as, but not limited to, a heavy knotted fishing net, or made from a suitable material such as nylon, for example. While mesh may be selected that is thin and has larger squares (e.g., holes) to reduce any impact on the currents in the fish tank as well as reduce any effect on image processing on the acquired images. For example, overlaps in mesh “strands” create nodes, which may potentially create false readings within any image recognition artificial intelligence (AI) that may be used. However, if the mesh is too thin and the holes are too large, it may be easier for a fish to bite the mesh thereby creating larger holes such that the fish can get caught in the mesh and get injured or even die. As previously noted, the mesh is preferably made of a material that is as chemically inert as possible in saline/fresh water, strong enough to withstand biting/chewing of the fish, thin enough to not obstruct the illuminating area and porous enough to let water and light flow through.

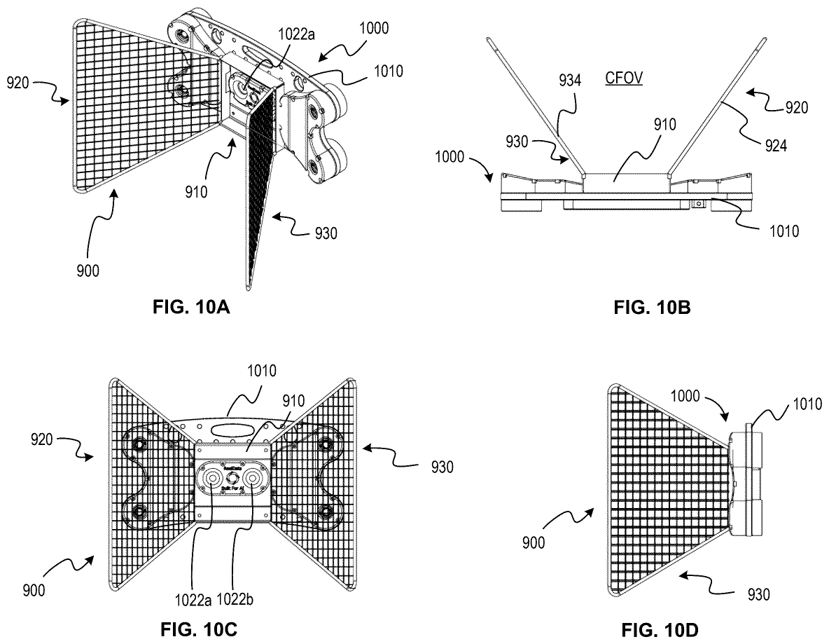

Referring now to FIGS. 10A-10D, shown therein are perspective, top, front, and side views, respectively, of an example embodiment of an underwater camera 1000 having a housing 1010 to which the fish deterrent 900 is attached. The camera 1000 may be the same as the camera 200. The fish deterrent 900 may be “attached” to the housing 1010 of the camera 1000 in any number of ways. For example, the fish deterrent 900 may be attached to the camera housing 1010 permanently, such as by welding joints, etc. Alternatively, the fish deterrent 900 may be attached to the camera housing 1010 so that it is removably attached, such as by using releasable fasteners like nuts, bolts, or screws, or a sliding locking mechanism, or a high-strength magnet, etc. A releasable attachment may be preferable to remove the fish deterrent when it needs to be replaced or undergo maintenance for repairs, for example.

The attachment frame 910 is attached to the front of the camera housing 1010 such that the walls and plates of the attachment frame 910 are situated around the image sensors 1022a and 1022b of the camera 1000 as shown in FIGS. 10B and 10C. Accordingly, the open space 905 is aligned with the image sensors 1022a and 1022b so that the mount does not block the FOV of the image sensors 1022a and 1022b. The barrier 920 has a trapezoidal shape that extends outwardly from a first outer side of the image sensor 1022a. The barrier 930 has a trapezoidal shape that extends outwardly from a second outer side of the image sensor 1022b. The barriers 920 and 930 extend away at horizontal and vertical angles from the camera housing 1010 on either side of the image sensors 1022a, 1022b so that the barriers 920 and 930 encompass the CFOV/working area of the image sensors 1022a, 1022b. The horizontal and vertical angles are defined with respect to a plane defined by the front face/surface of the camera. This generally applies to a majority of the fish deterrent embodiments described herein except for embodiments with central deterrents where the central deterrent just extend from the camera body at a vertical angle as the central deterrent may be substantially vertical.

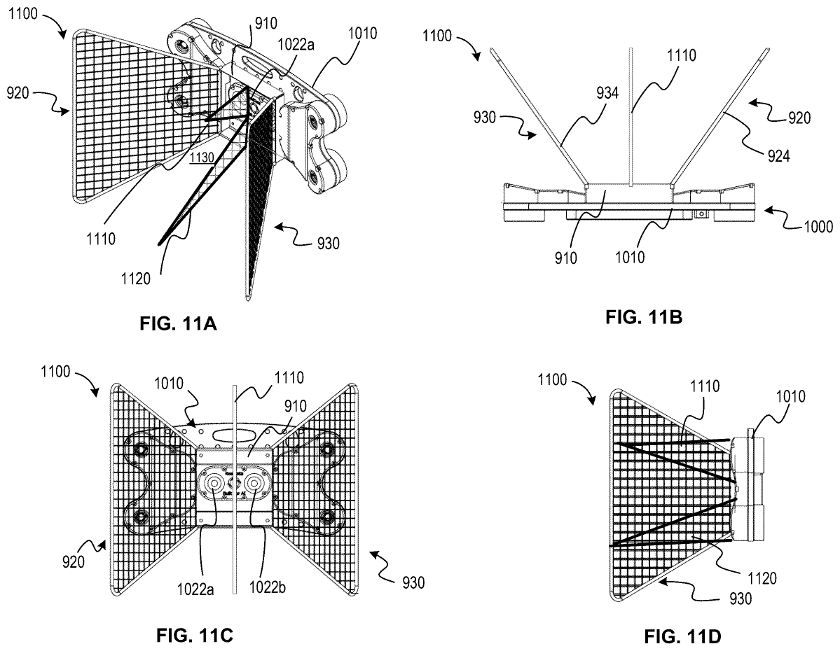

Referring now to FIGS. 11A-11D, shown therein are perspective, top, front, and side views, respectively, of the camera 1000 with another example fish deterrent 1100 attached to the camera housing 1010. The fish deterrent 1100 is structured mostly similar to the fish deterrent 900 and is attached to the camera housing 1010 in a similar manner as the fish deterrent 900. However, the fish deterrent 1100 also has a central deterrent member (e.g., central barrier or intermediate barrier) having upper and lower portions 1110 and 1120 defining a space therebetween 1130. The intermediate barrier portions 1110 and 1120 are planar and advantageously prevent smaller fish from getting too close to the image sensors 1022a, 1022b and/or remaining stationary in the FOV of the image sensors 1022a, 1022b.

The central deterrent of the fish deterrent 1100 has an arched shape similar to what was described in FIG. 7D. For example, the upper and lower central deterrent members 1110 and 1120 may have triangular shapes. The central deterrent members 1110 and 1120 have frames to which mesh is attached in a similar manner as deterrent sidewalls 920 and 930. A portion of a rear segment of the upper central deterrent is attached to the upper sidewall 910 and mounting plate 913 while a portion of a rear segment of the lower central deterrent is attached to the lower sidewall 914 and the mounting plate 915. In at least one embodiment, the attachment frame may also have a central vertical rod that is attached to the upper and lower sidewalls 910 and 914 and the mounting plates 914 and 915. The rear segments of the upper and lower central deterrent members 1110 and 1120 may be attached to the central vertical rod for additional support. Accordingly, the upper and lower central deterrent members 1110 and 1120 extend outwardly from a central portion of the camera housing 1010 between the two image sensors 1022a and 1022b. However, the shapes of the upper and lower central deterrent members 1110 and 1120 may have different shapes where the shapes are preferably selected to have a reduced effect (e.g. may be minimally captured in images) on the CFOV of the camera 1010 and have a central gap or space between them.

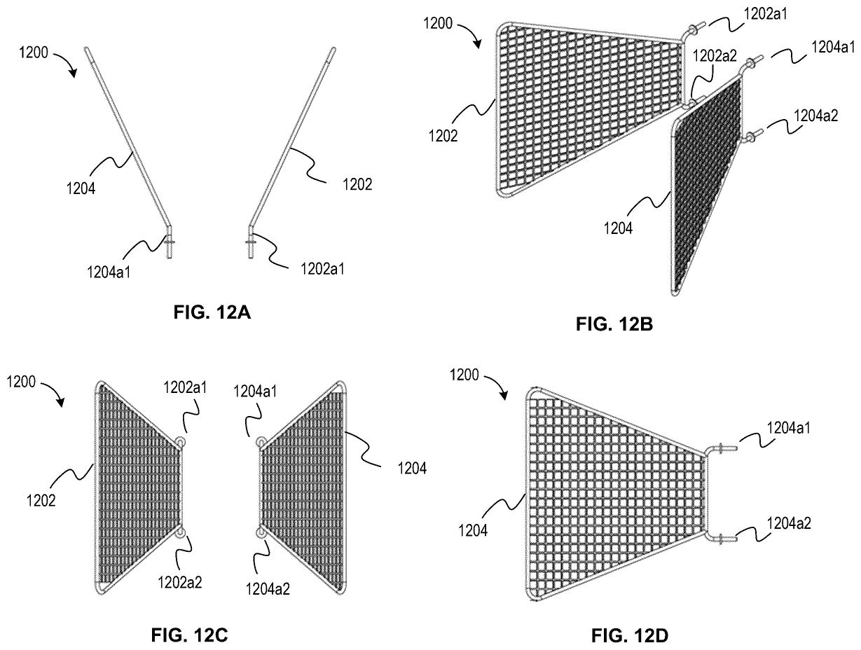

Referring now to FIGS. 12A-12D, shown therein are top, perspective, front, and side views, respectively, of an example embodiment of a fish deterrent 1200 for use with an underwater camera for underwater imaging. The fish deterrent 1200 is similar to the fish deterrent 900 except that different attachment elements are used. The fish deterrent 900 incorporated an attachment plate 910 to which the side barriers 920 and 930 were attached and the attachment plate 910 was used to mount the deterrent to a camera housing. However, for the fish deterrent 1200, the side barriers 1202 and 1204 are physically separate pieces and have their own attachment elements, respectively.

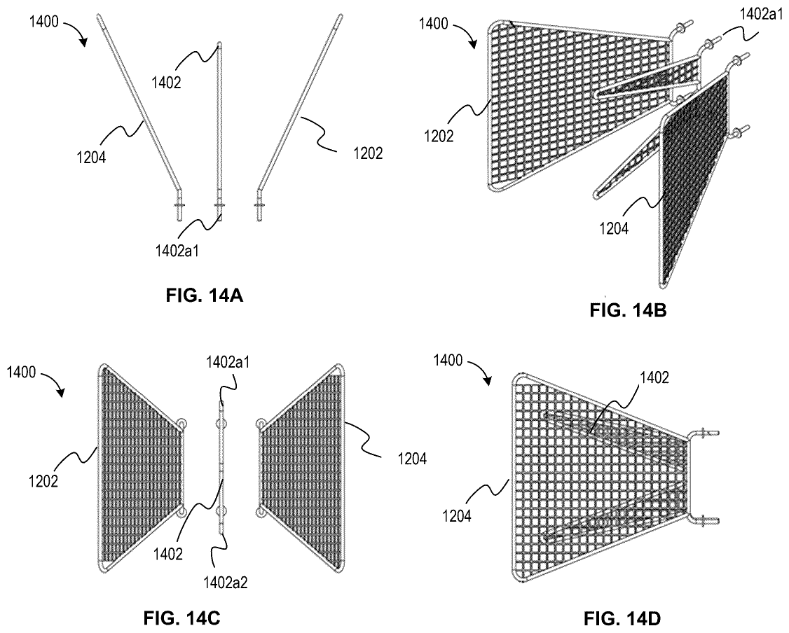

The physical structure of the barriers 1202 and 1204 have several benefits including using less material, being easier to ship and also making it easier to repair the barriers 1202 and 1204 individually rather than having to replace the entire deterrent as might be the case for deterrent 900 depending on the type of repair that is needed. Furthermore, since the barriers 1202 and 1204 are individual pieces it is easier to have different configurations for the deterrent such as when only one of the side barriers 1202 and 1204 are used, combining one of the side barriers 1202 and 1204 with a central deterrent that has a similar attachment element as the barriers 1202 and 1204 or combining both of the side barriers with a central deterrent having a similar attachment element as is shown in FIGS. 14A to 19D.

In this example embodiment, the respective attachment elements may have a cylindrical shape and may be bent rods and are positioned such that they extend away from the top and bottom portions of the rear segment of each side barrier. The attachment elements 1202a1 and 1202a2 are at the top and bottom, respectively, of the rear segment of side barrier 1202 while the attachment elements 1204a1 and 1204a2 are at the top and bottom, respectively, of side barrier 1204. The attachment elements 1202a1 and 1202a2 may be integrally formed with the rear segment of side barrier 1202 and the attachment elements 1204a1 and 1204a2 may be integrally formed with the rear segment of side barrier 1204. Each of the attachment elements 1202a1, 1202a2, 1204a1 and 1204a2 may have a washer or spacer and an end rod portion that are used to mount the side barriers 1202 and 1204 to the housing of an underwater camera. The attachment elements 1202a1, 1202a2, 1204a1 and 1204a2 may be made from a sturdy material that does not corrode in fresh water/saline and/or has a coating that does not corrode in fresh water/saline similar to attachment frame 910.

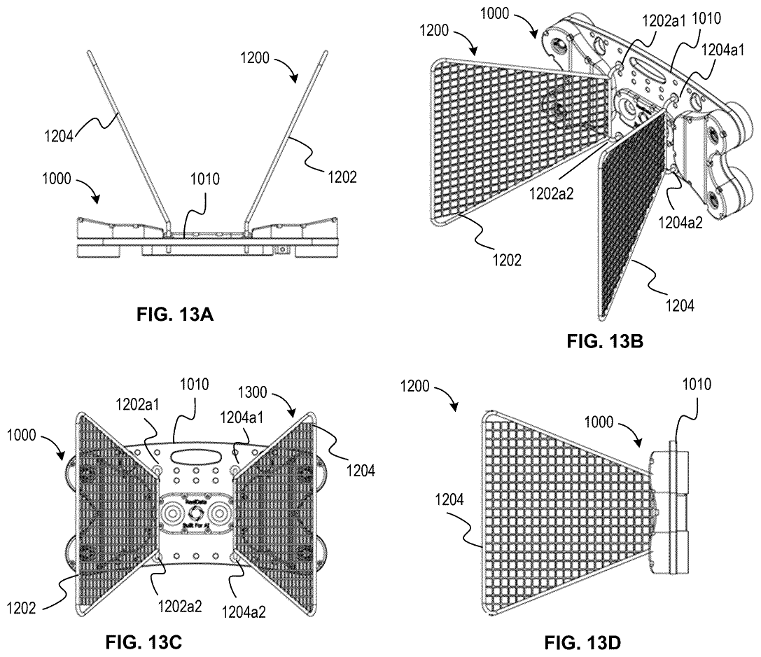

Referring now to FIGS. 13A-13D, shown therein are top, perspective, front, and side views, respectively, of the fish deterrent 1200 of FIGS. 12A-12D attached to the underwater camera 1000 for underwater imaging. As can be seen the side barriers 1202 and 1204 are directly releasably mounted to the housing 1010 (e.g., chassis or support plate) of the underwater camera 1200. The side barriers 1202 and 1204 are mounted to the underwater camera 1200 using the same principles as for the fish deterrent 900 so that the side barriers 1202 and 1204 are on either side of the CFOV of the underwater camera 1000. Therefore, the side barriers 1202 and 1204 can have similar dimensions and be angled in a similar manner as side barriers 920 and 924.

The attachment elements 1202a1 and 1202a2 are slid through apertures in the camera housing 1010 such that a flange or washer on these attachment elements preferably makes contact with the front surface of the camera housing 1010. A fastener (not shown) such as a nut may then be slid onto the end of the attachment elements 1202a1 and 1202a2 which are now protruding out of the rear surface of the camera housing 1010. The fastener is releasably tightened to securely hold the side barrier 1202 in a fairly rigid position so that the deterrent is approximately stationary. The side barrier 1204 is releasably mounted in a secured fashion to the camera housing 1010 in a similar manner as was described for side barrier 1202.

Referring now to FIGS. 14A-14D, shown therein are top, perspective, front, and side views, respectively, of an example embodiment of a fish deterrent 1400 for use with an underwater camera for underwater imaging. The fish deterrent 1400 is similar to fish deterrent 1100 in that there are three deterrent members including side barriers 1202 and 1204 and a central deterrent/barrier 1402. However, similar to fish deterrent 1200, the barrier elements 1202, 1204 and 1402 use an attachment element that is rod-like/cylindrical (e.g., prong-like) although other similarly shaped elements may be used like hooks, for example. Accordingly, the central deterrent 1402 includes attachment elements 1402a1 and 1402a2 at the top and bottom end portions of the rear segment. The attachment elements 1402a1 and 1402a2 may also include a washer as was described for side deterrents 1202 and 1204. The fish deterrent 1400 has similar benefits as fish deterrent 1200.

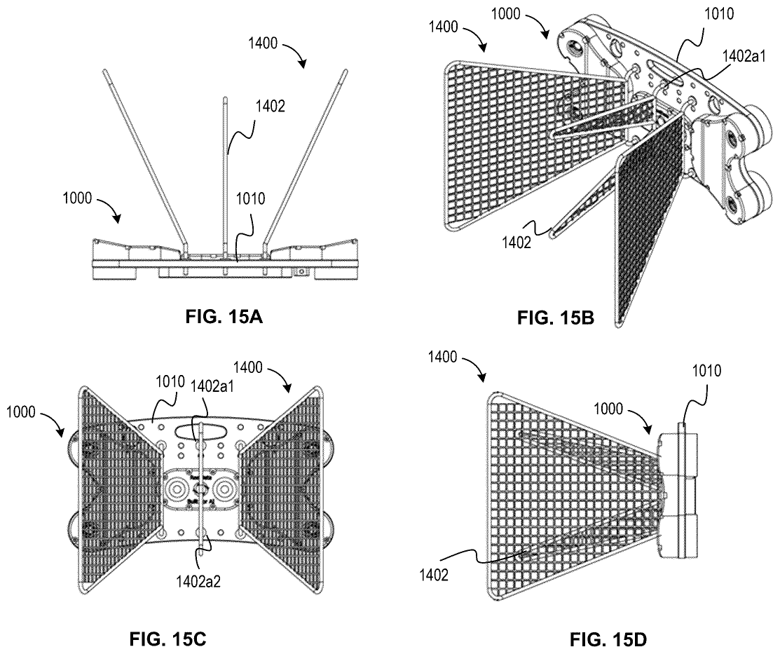

Referring now to FIGS. 15A-15D, shown therein are top, perspective, front, and side views, respectively, of the fish deterrent 1400 of FIGS. 14A-14D attached to the underwater camera 1000 for underwater imaging. The central deterrent 1402 is releasably mounted to the camera housing 1010 as was described for barrier element 1202. The deterrents 1202, 1204 and 1402 may be mounted according to a similar geometry as was explained for the mounting of fish deterrent 1100 to camera 1000 (see FIGS. 11A-11D.

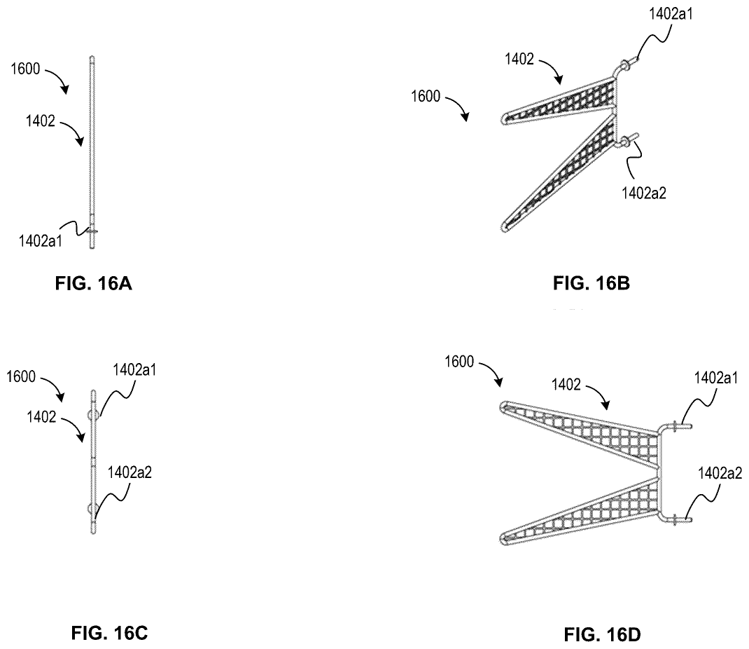

Referring now to FIGS. 16A-16D, shown therein are top, perspective, front, and side views, respectively, of an example embodiment of a fish deterrent 1600 that comprises only a central deterrent 1402 which is the same as that used for the central deterrent of fish deterrent 1400. The fish deterrent 1600 can be mounted to the camera housing 1010 in a similar manner as was described for side deterrent 1202 with the same geometric relationship relative to the image sensors as was described for the central deterrent of fish deterrent 1100.

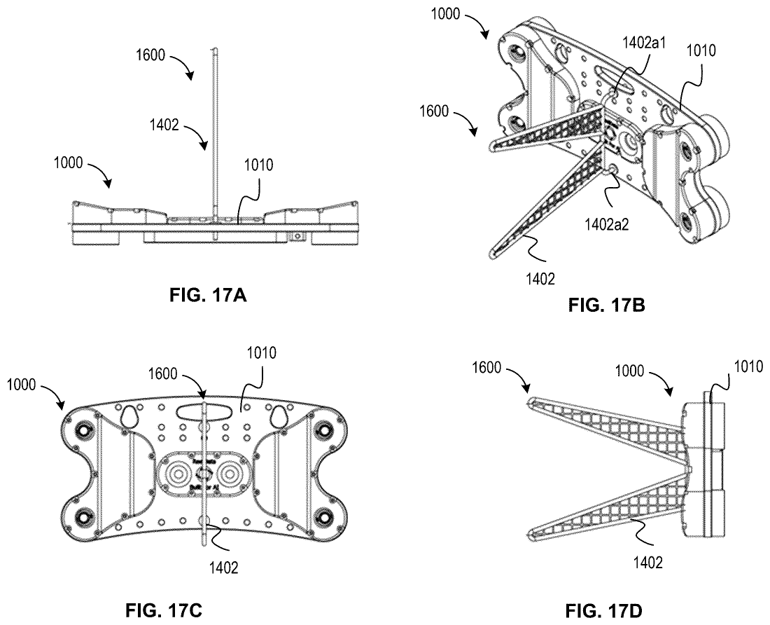

Referring now to FIGS. 17A-17D, shown therein are top, perspective, front, and side views, respectively, of the fish deterrent 1600 attached to the underwater camera 1000 for underwater imaging. Advantageously, since the fish deterrent 1600 does not include the side barriers there will not be any small-fish eddy effect which would otherwise have attracted small fish to the underwater camera 1000. However, this must be balanced with allowing larger fish to partially be in the CFOV since the side barriers are not there to impede/deter the large fish and so it may be more difficult to image such fish if they cannot totally fit within the CFOV.

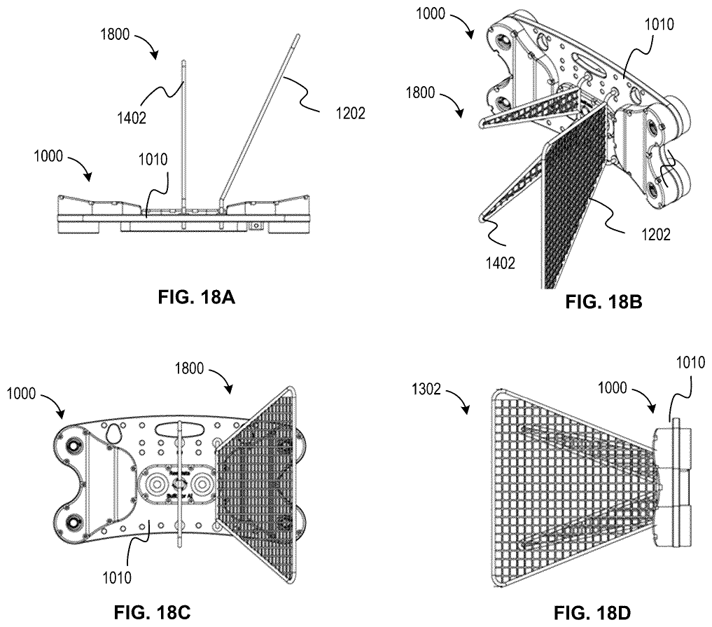

Referring now to FIGS. 18A-18D, shown therein are bottom, perspective, front, and side views, respectively, of an example embodiment of a fish deterrent 1800 attached to underwater camera 1000 for underwater imaging. The fish deterrent 1800 is similar to fish deterrent 1400 but has only side deterrent 1202 and central deterrent 1402. The fish deterrent 1800 can be mounted to the camera housing 1010 in a similar manner as was described for side deterrent 1202 and central deterrent 1402 previously with respect to the description of fish deterrents 1200 and 1400.

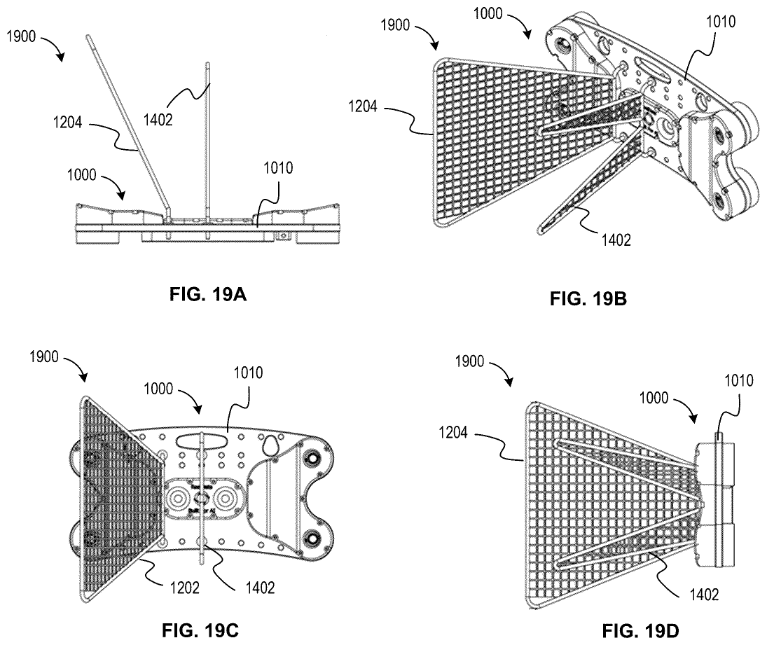

Referring now to FIGS. 19A-19D, shown therein are bottom, perspective, front, and side views, respectively, of an example embodiment of a fish deterrent 1900 attached to underwater camera 1000 for underwater imaging. The fish deterrent 1900 is similar to fish deterrent 1400 but has only side deterrent 1204 and central deterrent 1402. The fish deterrent 1900 can be mounted to the camera housing 1010 in a similar manner as was described for side deterrent 1202 and central deterrent 1402 previously with respect to the description of fish deterrents 1200 and 1400.

Advantageously, since the fish deterrents 1800 and 1900 do not include one of the side barriers there will be less of a small-fish eddy effect which would otherwise have attracted small fish to the underwater camera 1000. Also, since one side barrier is used there may still be deterrence of larger fish from swimming too closely to the camera 1000 and only partially being in the CFOV so the fish deterrents 1800 and 1900 may still help with imaging the entirety of a larger fish. These center-side fish deterrents 1800 and 1900 may be used such that the side barrier is either downstream of the stereo camera 1000 or upstream of the stereo camera 100 depending on fish stocking size (e.g., with smaller fish, the side barrier can be downstream of the stereo camera 1000, while with larger fish the side barrier can be upstream of the stereo camera 1000).

It should be noted that the various fish deterrent embodiments described herein are useable with the various stereo camera embodiments such as those described herein. In addition, the size of the deterrent is generally selected based on the desired interaction between the deterrent and the camera system as described previously. In turn, the design of the camera system is based on the fish that are being monitored and for which biomass estimates are being made.

It should also be noted that the various lighting control systems hardware and software embodiments described herein may be used with cameras that only have one image sensor. Alternatively, or additionally, any of the fish deterrent embodiments described herein may also be used with cameras that only have one image sensor. In such embodiments, the hardware and software of the lighting control system and/or fish deterrents are designed, structured and dimensioned to match the working area of the single camera in generally the same manner as was described for stereo cameras. For example, the fish deterrent and lighting control systems are preferably designed to maximize the effective working area of the single image sensor camera and minimize the possibility for small fish to block the field of view. In this case, the field of view is the entire field of view of the single image sensor and not the combined field of view for a stereo pair of image sensors. In another example, when a central deterrent is used with a camera having a single image sensor then the rear segment placed near the camera housing may be discontinuous so that it does not cross in front of the image sensor (e.g., the central deterrent may have the top and bottom members separate from one another and separately securely removably mounted to the camera housing).

It should be noted that the various embodiments described herein can be used in a aquaculture tank, which may be land-based or water-based, and are not limited for use in a fish farm.

It should also be noted that the various embodiments described herein may be used for tanks containing different types of marine life, which may be land-based or water-based, and are not limited to fish tanks.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A fish deterrent for use with an underwater camera having a camera housing and at least one image sensor for underwater imaging wherein the fish deterrent comprises:
a least one fish deterrent barrier; and
an attachment element for releasably mounting the at least one fish deterrent to the camera housing,
wherein the at least one first deterrent barrier extends outwardly from the camera housing in a same direction as a field of view (FOV) of the camera.

2. The fish deterrent of claim 1, wherein the at least one fish deterrent barrier comprises a first deterrent side barrier that extends outwardly from the camera housing with respect to a first side of the at least one image sensor in the same direction of the FOV of the camera; and/or the at least one fish deterrent comprises a second deterrent side barrier that extends outwardly from the camera housing with respect to a second side of the last one image sensor in the same direction as the FOV of the camera.

3. The fish deterrent according to claim 2, wherein the deterrent side barrier is a sidewall that is vertically oriented defining an open face, an open top and an open bottom for the fish deterrent.

4. The fish deterrent according to claim 2, wherein the sidewalls are angled outwards with respect to a plane defined by the at least one image sensor, and the amount of the angle is selected so that the deterrent side barriers encompass a combined FOV of a stereo camera.

5. The fish deterrent according to claim 1, wherein the at least one fish deterrent barrier includes a central deterrent barrier that extends outwardly from the camera housing in the same direction as the FOV and within the FOV of the camera.

6. The fish deterrent according to claim 5, wherein the central deterrent barrier has an arciform shape; and/or wherein the central deterrent barrier has upper and lower members defining a space therebetween.

7. The fish deterrent according to claim 5, wherein the camera has two image sensors, and the central deterrent barrier is mounted between the two image sensors.

8. The fish deterrent according to claim 1, wherein the at least one deterrent barrier is made of material having holes to have a reduced effect on current at a location of the camera.

9. The fish deterrent according to claim 2, wherein a given deterrent side barrier has a frame with upper front, lower front and rear segments and the frame has a trapezoidal shape with the rear segment being shorter than the front segment and the rear segment being adjacent to the camera housing.

10. An underwater camera for use in one or more aquaculture fish tanks, wherein the camera comprises:
a housing;
at least one image sensor mounted on the housing;
two or more light sources that are independently controllable for generating light beams, the two or more light sources being mounted at the housing laterally offset from the at least one image sensor with the at least one image sensor located between the two or more light sources; and
a lighting control system having a computing device that is configured to dynamically adjust light intensity of the generated light beams from at least one of the two or more light sources.

11. The underwater camera of claim 10, comprising at least two image sensors mounted at the housing.

12. The underwater camera according to claim 10, wherein the lighting control system comprises:
light source driver circuitry for providing drive currents to the light sources; and
a microcontroller that is configured for generating and sending light control signals to the light source driver circuitry for controlling an intensity of the light beams generated by at least one of the at least two light sources based on instructions received from the computing device.

13. The underwater camera according to claim 12, wherein the light sources are LEDs and the microcontroller uses pulse width modulation for the light control signals used to control the operation of the two or more light sources, wherein the pulse width modulation is performed at a high frequency of 1 KHz or more.

14. The underwater camera according to claim 13, wherein capacitors are coupled to each of the light sources to smooth out any variation in light intensity of the generated light beams.

15. The underwater camera according to claim 10, wherein the light control signals are adapted so that any change to light intensity of the generated light beams is made in a gradual fashion.

16. The underwater camera according to claim 10, wherein the lighting control system includes power supply circuitry that is configured to provide a first power supply voltage level to the light source driver circuitry and a second power supply voltage to an edge computing device where the first power supply voltage level is higher than the second power supply voltage level.

17. The underwater camera according to claim 10, wherein the microcontroller generates the light control signals so that the light intensity of the light beams generated by each light source is in the range of about 0 lumens to about 4,000 lumens each.

18. The underwater camera according to claim 10, wherein the light sources are angled with respect to a front face of the housing so that the generated light beams are directed in an inward fashion to provide an increase in illumination for a field of view of a single image sensor when the at least one image sensor is the single image sensor or for a combined field of view for a stereo pair of image sensors when the at least one image sensor is the stereo pair of image sensors.

19. The underwater camera according to claim 10, wherein the computing device receives control commands from a remote device operated by a user and processes the control commands to generate instructions that are provided to the microcontroller and/or the underwater camera wherein the control commands include values for any combination of basic camera settings, advanced camera settings and light control parameters.

20. The underwater camera according to claim 19, wherein the basic camera settings include any combination of exposure, contrast and brightness.

21. The underwater camera according to claim 19, wherein the advanced camera settings include any combination of gain, gamma, saturation, white balance, hue and sharpness.

22. The underwater camera according to claim 10, wherein the computing device is configured to execute software for implementing an automated lighting control method to determine image quality for a current image and to determine control instructions when the image quality is not acceptable.

23. The underwater camera according to claim 22, wherein the image quality is determined based on any combination of light/darkness, average pixel intensity, histogram spread, one or more color balance metrics, blur, sharpness, contrast, noise, color accuracy, and dynamic range.

24. The underwater camera according to claim 22, wherein the image quality is determined using an image quality Machine Learning (ML) model and wherein the control instructions are determined using one or more control instruction recommendation ML models that are provided with input features based on any combination of the current image, the current camera settings and the current light control settings.

25. The underwater camera according to claim 24, wherein the input features include any combination amount of light/darkness, average pixel intensity, histogram spread, one or more color balance metrics, blur, contrast, edge sharpness, specular reflections and backscatter metrics and edge detection measures.

26. The underwater camera according to claim 25, wherein at least one environmental measurement is provided as one of the input features to the one or more control instruction recommendation ML model(s).

27. The underwater camera according to claim 26, wherein the at least environmental measurement includes fish stocking density data, time data, temperature data, current lighting condition data, or any combination thereof.

28. The underwater camera according to claim 22, wherein the control instructions include light intensity control, polarization filtering control, spectral processing control, camera settings control, or any combination thereof.

29. The underwater camera of claim 27, wherein the camera settings control instructions include any combination of exposure rate, gain, color balance, capture rate, brightness, contrast, white balance, gamma, hue, saturation, and sharpness.

30. The underwater camera according to claim 10, further comprising a polarization filter for reducing glare and/or specular reflection.

31. The underwater camera according to claim 10, further comprising a fish deterrent that includes a least one fish deterrent barrier; and an attachment element for releasably mounting the at least one fish deterrent to the housing of the underwater camera, wherein the at least one first deterrent barrier extends outwardly from the housing of the underwater camera in a same direction as a field of view (FOV) of the underwater camera.

32. A system for allowing underwater monitoring of marine life in an aquaculture tank, wherein the system comprises:
a networking unit that is adapted to be removably mounted to the aquaculture tank, the networking unit providing power and network communications; and
an underwater camera having a lighting control system, the underwater camera being coupled to the networking unit and adapted for placement with the aquaculture tank, wherein the underwater camera is defined according to claim 10.

33. A method for performing underwater monitoring of marine life in an aquaculture tank, wherein the method comprises:
using an underwater camera in the aquaculture tank, the underwater camera being defined according to claim 10;
providing a monitor and control interface on a display of a remote device to a user, the interface showing at least one image acquired by the underwater camera, current values for camera settings and/or light control parameters of the underwater camera;
receiving updated values for the camera settings and/or the light control parameters from the user;
sending the updated values to the underwater camera from the remote device; and
adjusting the camera settings and/or light control parameters based on the updated values.

34. The method according to claim 33, wherein the camera settings comprise any combination of exposure, contrast, brightness, gain, gamma, saturation, white balance, hue and sharpness.

35. The method according to claim 33, wherein the method comprises performing an automated lighting control method to determine image quality for a current image and to determine control instructions when the image quality is not acceptable.
